(19) United States
(12) Patent Application Publication
(10) Pub. No.: US 2011/0033779 A1
(43) Pub. Date: Feb. 10, 2011

(54) Insulation for SOFC Systems

(76) Inventors: Michael Edward Badding, Campbell, NY (US); Thomas Dale Ketcham, Big Flats, NY (US); Sasha Marjanovic, Painted Post, NY (US); Dell Joseph St. Julien, Watkins Glen, NY (US)

Correspondence Address: CORNING INCORPORATED, SP-TI-3-1, CORNING, NY, 14831, US

(21) Appl. No.: 12/667,734

(22) PCT Filed: Jul. 1, 2008
(86) PCT No.: PCT/US08/08189

§ 371 Date: Jan. 5, 2010

Related U.S. Application Data
(60) Provisional application No. 60/958,409, filed on Jul. 5, 2007.

(51) Int. Cl. H01M 8/10

(52) U.S. Cl. 429/495

(57) ABSTRACT

The invention is directed to insulating compositions for use in solid oxide fuel cells. Such compositions can be used to prevent seal damage and increase the electrical and ion efficiency.

### CLAIM FOR PRIORITY

This application claims priority to U.S. Provisional Application No. 60/958,409, filed Jul. 5, 2007, which is incorporated by this reference in its entirely.

### FIELD OF THE INVENTION

The present invention relates to insulation for solid oxide fuel cell (SOFC) systems.

### TECHNICAL BACKGROUND

SOFC systems typically produce DC electrical power by reacting fuels with oxygen from air in single cells. Multiple DC cells are electrically connected in series or parallel, usually in series to increase voltage. For SOCF's using H₂ as a fuel and oxygen from the air as an oxidizer, each cell can produce about 1.1-1.2 volts at open circuit and may produce power at between 1.1-0.5 volts per cell at temperatures of 400° C.-1,000° C. When multiple cells are connected in series, substantial voltages can occur.

One SOFC design features multiple cells on a single sheet of electrolyte. At least one sheet and usually two electrolyte sheets are sealed to a frame where the fuel flows between the electrolyte sheet(s) and inside the frame. The combination of at least one sheet (usually two electrolyte sheets with multiple cells) and frame is known as a packet. A substantial voltage difference appears between different areas on the electrolyte and between the electrolyte and a conducting (sometimes grounded) packet frame. This voltage, for example up to ˜+/−18 volts open circuit for sixteen cells connected in series on one electrolyte sheet, can electrochemically degrade and destroy glass seals where chemical components of the seal move under electric field at the operating temperature of the SOFC system. The sign, magnitude, and location of the voltage between the seal and the frame in a multiple cell electrolyte design depends upon whether the frame is grounded, ungrounded (“floats”), or if the frame is connected to a particular cell and particular electrode to determine (“pin”) the potential of the frame.

As discovered herein in the present invention, plasma sprayed alumina (PSA) coatings on metal solid oxide fuel cell components can have mechanical failure in the PSA layer. CTE mismatch and microstructure or defects in the microstructure of the PSA coating may play a significant role in the fracture of the coating. The magnesium aluminate spinel plus magnesia coatings can react detrimentally with some glass seals.

As discovered herein in the present invention, in addition to seal degradation and power loss/efficiency losses, stray parasitic electrical or ionic currents in SOFC systems can cause other degradation material reactions, particularly in multi-cell designs on a single electrolyte sheet. In such multi-cell systems, a voltage of about 2.2-2.4 volts can exist across the gap between the cells (called a via gallery), between the anode on one cell and the un-connected cathode of an adjacent cell of less than 1 mm distance. Stray/parasitic oxygen ion or electronic current can flow across this 1 mm or less gap, reducing the power output of the device, and this current may cause material/structure degradation by a variety of mechanisms.

As discovered herein in the present invention, there are also efficiency losses associated with the “short-circuit” regions near the via electrical interconnects. For certain SOFC designs, which have multiple cells electrically interconnected through a continuous electrolyte support, the presence of an electronically conductive element which traverses from the cathode side to the anode side—i.e. the “via-fill”—surrounded by ionically conductive electrolyte support (i.e. 3YSZ), produces a small electrical short, a parasitic current, local to the via.

There is a need to address the aforementioned problems and other shortcomings of SOFCs, especially those containing multiple cells connected in series. These needs and other needs are satisfied by the insulation technology of the present invention.

### SUMMARY OF THE INVENTION

In one aspect, the present invention relates to the use of insulation in particular locations of the SOFC. In another aspect, the present invention utilizes particular insulation compositions. The present invention addresses at least a portion or all of the problems described above through the use of either the insulation location or composition. The compositions can be used for components and parts of components, such as layers on conducting frames, insulating frames, layers and insulating regions in or on the electrolyte. These insulating compositions prevent, minimize, or reduce electrochemical seal degradation, power loss, and/or stray/parasitic electrical and ionic reactions in SOFC systems.

In a first detailed aspect, the present invention provides a solid oxide fuel cell comprising a cathode, an anode, an electrolyte, a bus bar, a via pad, a seal, and an insulating amount of an insulating composition, wherein the insulating composition is proximate to the bus bar and/or the via pad and/or is present in part of the electrolyte, wherein the insulating composition is not substantially disposed between the cathode and the electrolyte.

In a second detailed aspect, the present invention provides a solid oxide fuel cell comprising a cathode, an anode, an electrolyte, a bus bar, a via pad, a seal, and an insulating amount of an insulating composition, wherein the insulating composition is proximate to the bus bar and/or the via pad and/or is present in part of the electrolyte, wherein the insulating composition is not lanthanum zirconate or strontium zirconate.

In another detailed aspect, the present invention n provides a solid oxide fuel cell comprising a cathode, an anode, an electrolyte, a bus bar, a via pad, a seal, and an insulating amount of an insulating composition comprising one or more insulating oxide ceramics having the following crystal structure class, super class, derivative structure or superstructure of the following crystal structure type:
i) pyrochlore or distorted pyrochlore,
ii) perovskite, distorted perovskite, superstructure of perovskite, or interleaved perovskite-like structure,
iii) fluorite, distorted fluorite, fluorite like, anion defective fluorite, sheelite, fergusonite, or flourite related ABO₄ compound,
iv) spinel, spinel derived structure, or inverse spinel,
v) rock salt structure,
vi) ilmenite,
vii) pseudobrookite A₂BO₅,
viii) stoichiometric structure based on ReO₃-like blocks,
ix) bronze or tetragonal bronze structure based on ReO₃-like blocks,
x) rutile;
xi) trirutile crystal structure or columbite crystal structure of AB₂O₆,
xii) cubic rare earth (C-M₂O₃) structure, or
xiii) corundum, or
a mixture thereof or a solid solution thereof,
wherein the insulating composition is proximate to the bus bar and/or the via pad
and/or is present in part of the electrolyte.

In another detailed aspect, the present invention provides a solid oxide fuel cell comprising a cathode, an anode, an electrolyte, a bus bar, a via pad, a frame, a seal, and an insulating amount of an insulating composition comprising one or more insulating oxide ceramics having the following crystal structure class, super class, derivative structure or superstructure of the following crystal structure types:
i) pyrochlore or distorted pyrochlore,
ii) perovskite, distorted perovskite, superstructure of perovskite, or interleaved perovskite-like structure,
iii) fluorite, distorted fluorite, fluorite like, anion defective fluorite, sheelite, fergusonite, or a flourite related ABO₄ compound,
iv) ilmenite,
v) pseudobrookite A₂BO₅,
vi) stoichiometric structure based on ReO₃-like blocks,
vii) bronze or tetragonal bronze structure based on ReO₃-like blocks,
viii) rutile,
ix) trirutile crystal structure or columbite crystal structure of AB₂O₆, or
x) cubic rare earth (C-M₂O₃) structure, or
a mixture thereof or a solid solution thereof,
wherein the insulating composition is proximate to the frame of the solid oxide fuel cell.

In another detailed aspect, the present invention provides a fuel cell system comprising at least two solid oxide fuel cells of the invention.

Additional aspects and advantages of the invention will be set forth, in part, in the detailed description, figures, and any claims which follow, and in part will be derived from the detailed description or can be learned by practice of the invention. The advantages described below will be realized and attained by means of the elements and combinations particularly pointed out in the appended claims. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate several aspects described below. Like numbers represent the same elements throughout the figures.

FIG. 1 shows the thermal expansion coefficient of various pyrochlores (rare earth zirconates) and zirconia 8 mole % yttria (YSZ).

FIG. 2 shows electrical resistivity as a function of temperature for rare earth stanates and zirconates (pyrochlore structures) measured in an atmosphere of 1 bar of oxygen or 10⁻³ bar of oxygen.

FIG. 3 shows the electrical resistivity as a function of +3 to +5 cation ratio at 600° C. for distorted fluorite structures, ZrO₂—Y(RETH)Nb(Ta)O₄—Y(RETH)₂O₃.

FIG. 4 shows the thermal expansion coefficient of ZrO₂˜25 mole % YTaO₄˜0.5 mole % Ta₂O₅.

FIG. 5 shows an approximate phase diagram in the ZrO₂ rich corner of the ZrO₂—YNb(Ta)O₄—Y(RETH)O_{3/2} system at 1300-1600 C.

FIG. 6 shows an X-ray diffraction trace of Example 1, identifying a layer of a tetragonal crystal structure (distorted fluorite) of zirconia-yttrium tantalate on a tetragonal zirconia electrolyte with a minor amount of NiO.

FIGS. 7a and b show a SEM cross-section that is 7a (polished) or 7b (fractured) of Example 1, which is a layer of a tetragonal crystal structure (distorted fluorite) of zirconia-yttrium tantalate on a tetragonal zirconia electrolyte.

FIG. 8a shows an X-ray diffraction trace of Example 2, identifying a layer of a pyrochlore structure of Nd₂Zr₂O₇ on a tetragonal zirconia electrolyte.

FIG. 8b shows an SEM cross-section of fractured tetragonal zirconia electrolyte with a Nd₂Zr₂O₇ pyrochlore layer and with a thin dense layer of a reaction product as produced in Example 2.

FIG. 9a shows a top view of a pictorial representation of an electrolyte supported multiple-cell design of one aspect of the invention.

FIG. 9b shows a side view of a multiple-cell design along cut line A-A.

FIG. 9c is an exploded view of the metal filled via current path of one aspect of the invention.

FIG. 9d is an exploded view of the electrolyte sheet showing the via holes of one aspect of the invention.

FIG. 10 shows a schematic view of a multiple-cell design of one aspect of the invention along cut line A-A of FIG. 9a.

FIG. 11 is a schematic side view of a multiple-cell design of one aspect of the invention along cut line B-B of FIG. 9a.

FIG. 12a is a schematic showing bus bars, via pads and electrodes for a multi-cell design on a single electrolyte of one aspect of the invention.

FIG. 12b is a schematic showing regions/areas or volumes where the inventive insulating ceramics can be used on or in the electrolyte with a multi-cell design of one aspect of the invention.

FIG. 13 shows a schematic of an electrolyte with an insulating coating or volume/region underneath the bus bars and via galleries of a multi-cell device of one aspect of the invention.

FIG. 14 is a pictorial 3D representation of a packet of one aspect of the invention.

FIGS. 15a and 15b show a top-level view and a side level view of a schematic of an electrolyte with an insulating volume/region surrounding the active area and extending to make contact with the seal of one aspect of the invention.

FIGS. 16a and 16b are a top level view and a side level view of a schematic of an electrolyte with an insulating volume/region surrounding the active area but not making contact with the seal of one aspect of the invention.

FIG. 17 is a schematic diagram of the inventive insulating ceramic being used as a coating between a frame and a seal in an SOFC system of one aspect of the invention.

### DETAILED DESCRIPTION OF THE INVENTION

The present invention can be understood more readily by reference to the following detailed description, examples, and claims, and their previous and following description. However, before the present compositions, articles, devices, and methods are disclosed and described, it is to be understood that this invention is not limited to the specific compositions, articles, devices, and methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its currently known embodiments. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

Disclosed are materials, compounds, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. Thus, if a class of substituents A, B, and C are disclosed as well as a class of substituents D, E, and F and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

In this specification and in the claims which follow, reference will be made to a number of terms which shall be defined to have the following meanings:

As used herein, the singular forms “a,” “an” and “the” include plural referents unless the context clearly dictates otherwise. Thus, for example, reference to a “compound” includes aspects having two or more such compounds, unless the context clearly indicates otherwise.

“Optional” or “optionally” means that the subsequently described event or circumstance can or cannot occur, and that the description includes instances where the event or circumstance occurs and instances where it does not. For example, the phrase “optionally substituted component” means that the component can or can not be substituted and that the description includes both unsubstituted and substituted aspects of the invention.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, a “wt. %” or “weight percent” or “percent by weight” of a component, unless specifically stated to the contrary, refers to the ratio of the weight of the component to the total weight of the composition in which the component is included, expressed as a percentage.

As used herein, a “mole percent” or “mole %” of a component, unless specifically stated to the contrary, refers to the ratio of the number of moles of the component to the total number of moles of the composition in which the component is included, expressed as a percentage.

Re is rhenium.

RETH is defined herein to be a rare earth element (also known as a lanthanide), which includes herein Y and Sc.

As briefly introduced above, the present invention provides for a SOFC device that has an insulating material either in a particular location or of a particular composition. This invention overcomes the heretofore unknown and/or unrecognized problems with thin film alumina. The insulating compositions of this invention have low electronic and ion conductivity, as well as having thermal expansion coefficients nearly matched (or at least better matched than alumina) to the zirconia electrolyte or frame. The materials of this invention can also be sintered onto or reacted with the electrolyte to form an electronically and ionically insulating layer or region.

The insulating composition of the present invention is not intended to be in contact with the cathode. However, due to inadvertent overlap from the printing process, some insulation may contact the cathode, either on top of or underneath the cathode. The present invention, by the use of the term “not substantially disposed between the cathode and the electrolyte,” is intended to include this inadvertent overlap with the cathode. In various such aspects, at least 50 wt. %, at least 60 wt. %, at least 70 wt. %, at least 80 wt. %, at least 90 wt. %, at least 95 wt. %, at least 98 wt. % or at least 99 wt. % of the insulating composition proximate the bus bar and/or the via pad is not disposed between the cathode and the electrolyte.

In one aspect, the insulating composition is not lanthanum zirconate or strontium zirconate. In another aspect, the insulating composition is not a rare earth zirconate or an alkaline earth zirconate. In yet another aspect, the insulating composition comprises one or more insulating oxide ceramics. In one aspect, the insulating compositions have a melting point of at least 700° C.

In one aspect, the insulating composition comprises one or more insulating oxide ceramics having the following crystal structure class, super class, derivative structure or superstructure of the following crystal structure type:
i) pyrochlore or distorted pyrochlore,
ii) perovskite, distorted perovskite, superstructure of perovskite, or interleaved perovskite-like structure,
iii) fluorite, distorted fluorite, fluorite like, anion defective fluorite, sheelite, fergusonite, or flourite related ABO₄ compound,
iv) spinel, spinel derived structure, or inverse spinel,
v) rock salt structure,
vi) ilmenite,
vii) pseudobrookite A₂BO₅,
viii) stoichiometric structure based on ReO₃-like blocks, for example ReO₃, TiNb₂O₇, or Ti₂Nb₁₀O₂₉,
ix) bronze or tetragonal bronze structure based on ReO₃-like blocks,
x) rutile;
xi) trirutile crystal structure or columbite crystal structure of AB₂O₆,
xii) cubic rare earth (C-M₂O₃) structure, or
xiii) corundum, or
a mixture thereof or a solid solution thereof.

In a further aspect of the above, the insulating oxide ceramic comprises one or more of
i) pyrochlore or distorted pyrochlore crystal structure according to the formula
   (1) A₂B₂O₇ having the valence A³⁺₂B⁴⁺₂O₇, wherein
      A³⁺ is Sc, Y, La, Nd, Eu, Gd, or other 3+ lanthanide and
      B⁴⁺ is Zr, Ti, Hf, or Sn, or
   (2) A₂B₂O₇ having the valence A²⁺₂B⁵⁺₂O₇, wherein
      A²⁺ is Ca, Sr, Zn, or Ba,
      B⁵⁺ is Nb, Ta, or V;
ii) perovskite; distorted perovskite crystal structure; superstructure of Perovskite according to the formula ABO₃
   (1) having the valence A²⁺B⁴⁺O₃, wherein
      A²⁺ is Mg, Ca, Sr, or Ba and
      B⁴⁺ is Ti, Zr, Hf, or Sn, for example CaTiO₃,
   (2) having the valence A³⁺B³⁺O₃, wherein
      A³⁺ is Sc, Y, La, or a 3+ lanthanide and
      B³⁺ is Al, Ga, Cr, Sc, V, or Y,
      for example, the rhombohedral perovskite LaAlO₃, or
   (3) having the valence A²⁺(B³⁺_{0.5}B⁵⁺_{0.5})O₃, wherein
      A²⁺ is Ca, Sr, or Ba,
      B³⁺ is Al, Cr, Ga, Sc, Y, La, Ce, or other 3+ lanthanide,
      B⁵⁺ is V, Nb, Ta, or Sb,
      for example, Ca(La_{0.5},Ta_{0.5})O₃,
   (4) having the valence A²⁺(B²⁺_{0.33}B⁵⁺_{0.67})O₃, wherein
      A²⁺ is Ca, Sr, or Ba,
      B²⁺ is Mg, Ca, Cd, Ni, or Zn,
      B⁵⁺ is Nb, Ta, or Sb,
      for example, Ba(Ca_{0.33}, Nb_{0.67})O₃ or Ba(Sr_{0.33}, Ta_{0.67})O₃,
   (5) having the valence A²⁺(B²⁺_{0.5}B⁶⁺_{0.5})O₃, wherein
      A²⁺ is Ca, Sr, or Ba,
      B²⁺ is Mg, Ca, Sr, Ba, Cd, Ni, or Zn,
      B⁶⁺ is Mo, W or Re,
      for example, Ba(Sr_{0.5}W_{0.5})^{O}₃,
   (6) having the valence A³⁺_{0.33}B⁵⁺O₃, wherein
      A³⁺ is Y, La, Ce, Pr, Nd, Sm, Gd, Dy, Ho, or Er,
      B⁵⁺ is Nb or Ta,
      for example, La_{0.33}TaO₃, or
   (7) having the valence A³⁺(B²⁺_{0.5}B⁴⁺_{0.5})O₃, where A³⁺ is La or a lanthanide,
      B²⁺ is Mg, and B⁴⁺ is Ti, for example, La(Mg_{0.5},Ti_{0.5})O₃ or
      Nd(Mg_{0.5},Ti_{0.5})O₃;
   interleaved Bi₂O₂, for example, Bi₃NbTiO₉, Bi₄Ti₃O₁₂ or BaBi₄Ti₄O₁₅; or a perovskite-like structure,
iii)
   (1) fluorite or distorted fluorite of A_{1-x-y}BₓC_{y}O_{-z}, where A is Zr, Hf, or Ce, B is Mg, Ca, Y, Sc, or a rare earth, C is V, Nb, or Ta, where x<1, y<1, x+y<1, and z depends upon the valence of B and C, wherein, if B is 2+, then z=2+0.5y−x, and if B is 3+, then z=2+0.5y−0.5x,
   (2) fluorite like compound of A_{1-x-y}BₓC_{y}O_{z}, where A is Zr, Hf, or Ce, B is Mg or Ca, and C is W or Mo, where x<1, y<1, x+y<1, and z is 2+y−x,
   (3) a sheelite type structure of ABO₄, where A is Mg or Ca and B is W or Mo,
   (4) a fergusonite type structure of M^{III}NbO₄, M^{III}TaO₄ or M^{III}VO₄, where M^{III} is a metal of valence +3, or formula ABO₄ where A is Y or a rare earth and B is Nb, Ta or V,
   (5) an anion defective fluorite, or
   (6) a flourite related ABO₄ compound, with valence A²⁺B⁶⁺O₄ or A³⁺B⁵⁺O₃,
      wherein A²⁺ is Ca or Ba, B⁶⁺ is Cr, A³⁺ is Cr, and B⁵⁺ is Nb,
iv)
   (1) a spinel structure or a spinel derived structure of AB₂O₄, where A is Mg, Ni, Zn, Co, Fe, or Mn and B is Al, Ga, Cr, or Fe,
   (2) A₃B₃₂O₅₁, where A is Ca, Ba or Sr and B is Al,
   (3) an inverse spinel or A₂BO₄, wherein A is Mg or Zn and B is Ti or Sn,
v) rock salt structure AO, where A is Mg, Ca, Sr, Ba, or Ni,
vi) ilmenite of formula ABO₃, wherein A is Ni, Co, Mn or Fe and B is Ti, for example FeTiO₃, or giekielite where A is Mg and B is Ti, for example MgTiO₃,
vii) pseudobrookite crystal structure of the formula A₂BO₅, wherein A is Al or Fe and B is Ti, for example Al₂TiO₅,
viii) a tetragonal bronze structure based on ReO₃-like blocks, for example stoichiometric bronzes ReO₃, TiNb₂O₇ or Ti₂Nb₁₀O₂₉, or a Nb₂O₅—WO₃ mixture, for example WNb₂O₈ or Nb₁₂WO₆₃,
ix) a tetragonal bronze of valence A²⁺B⁵⁺₂O₆, wherein A²⁺ is Sr or Ba and B⁵⁺ is Nb or Ta, for example BaNb₂O₆ and SrNb₂O₆; or the superstructure A²⁺₅B⁵⁺₁₀O₃₀, A²⁺₆B⁴⁺₂B⁵⁺₈O₃₀, for example Ba₆Ti₂Nb₈O₃₀, Ca₂Sr₄Ti₂Nb₈O₃₀ or Ba₆Ti₂Ta₈O₃₀, or A²⁺₅B³⁺B⁴⁺₃B⁵⁺₇O₃₀, for example Sr₅LaTi₃Nb₇O₃₀, where A²⁺ is Ca, Sr, or Ba, B³⁺ is La or a lanthanide, B⁴⁺ is Ti, and B⁵⁺ is Nb or Ta,
x) rutile structure of AO₂, wherein A is Ti, Sn, or Mn,
xi) a trirutile crystal structure of AB₂O₆, for example MgTa₂O₆, Cr₂WO₆, MgSb₂O₆, or VTa₂O₆, where A is Mg, Cr, or V and B is Ta, W, or Sb; or other chain structure with trirutile stoichiometry, such as for example, CaTa₂O₆,
xii) a cubic rare earth (C-M₂O₃) structure A₂O₃, where A is Y or a rare earth, or
xiii) a corundum structure A₂O₃, where A is Al, Ga, or Cr, or ABO₃, wherein A is Ni and B is Cr,
or a mixture thereof or a solid solution thereof.

In yet a further aspect of the above, the insulating oxide ceramic comprises one or more of
i) Pyrochlore or distorted pyrochlore crystal structure of La₂Zr₂O₇, Y₂Zr₂O₇, Nd₂Zr₂O₇, Gd₂Zr₂O₇, Er₂Zr₂O₇, La₂Hf₂O₇, Y₂Hf₂O₇, Nd₂Hf₂O₇, Gd₂Hf₂O₇, Er₂Hf₂O₇, La₂Sn₂O₇, Y₂Sn₂O₇, Nd₂Sn₂O₇, Gd₂Sn₂O₇, or Er₂Sn₂O₇,
ii) perovskite, distorted perovskite crystal structure, superstructure of perovskite, or interleaved perovskite-like structure of SrZrO₃, BaZrO₃, SrHfO₃, BaHfO₃, SrSnO₃, BaSnO₃, BaTiO₃, or SrTiO₃,
iii) fluorite; distorted fluorite of A_{1-x-y}BₓC_{y}O_{z}, where A is Zr, Hf, or Ce and B is Mg, Ca, Y, Sc, or a rare earth and C is V, Nb, or Ta where x<1, y<1 and x+y<1 and y/x>0.5, and z depends upon the valence of B and C, wherein, if B is 2+, then z=2+0.5y−x, and if B is 3+, then z=2+0.5y−0.5x; fluorite like compound of A_{1-x-y}BₓC_{y}O_{z}, where A is Zr, Hf, or Ce, B is Mg or Ca and C is W or Mo, where x<1, y<1 and x+y<1 and y/x>0.5, and z is 2+y−x; sheelite type structure of ABO₄, where A is Mg or Ca, B is W or Mo; fergusonite type structure of M^{III}NbO₄, M^{III}TaO₄, or M^{III}VO₄; or formula ABO₄, where A is Y or a rare earth and B is Nb, Ta or V,
iv) spinel or spinel derived structure of MgAl₂O₄, ZnAl₂O₄, MnAl₂O₄, CoAl₂O₄,
v) a rock salt structure of MgO, CaO, SrO, or NiO, or
vi) rutile AO₂ structure, wherein A is Ti or Sn,
or a mixture thereof or a solid solution thereof.

Typically, the insulating composition proximate to the frame are any of the compositions recited above except for spinel, spinel derived structures, inverse spinel, rock salt structure, or corundum.

In one aspect, the insulating oxide ceramic is not Yttria stabilized zirconia or lanthanium zirconate. In another aspect, the insulating oxide ceramic is not a pyrochlore or distorted pyrochlore.

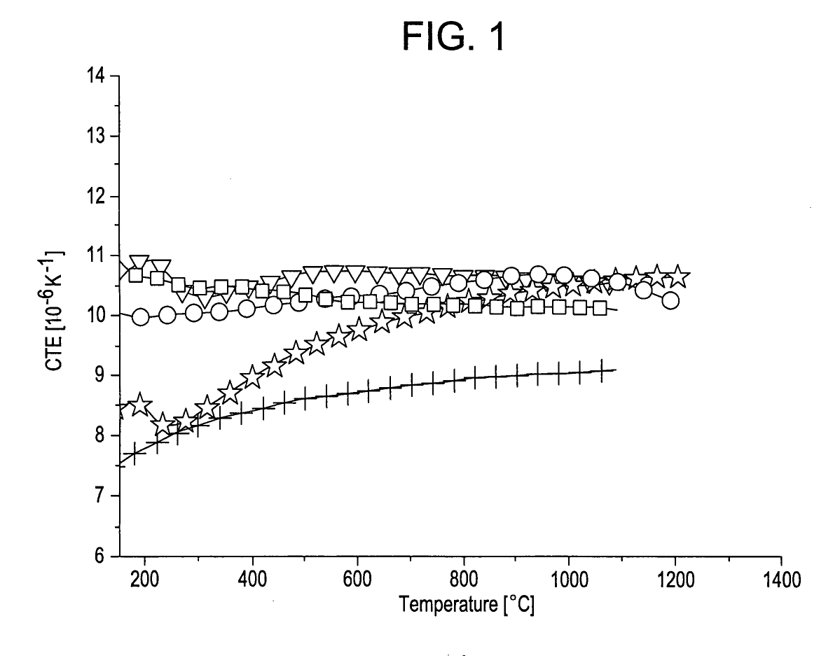

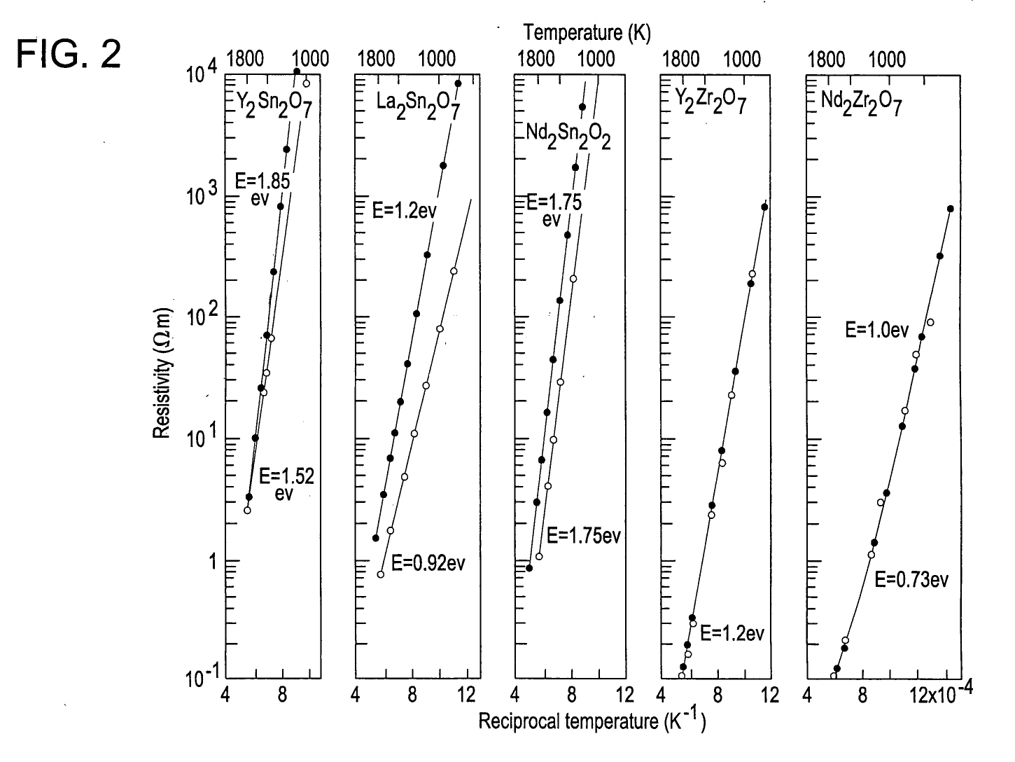

In a further aspect, the pyrochlore group includes Nd₂Zr₂O₇, Gd₂Zr₂O₇, Eu₂Zr₂O₇, Y₂Zr₂O₇, Y₂Sn₂O₇, Nd(RETH)₂Sn₂O₇ and solid solution of these compositions. Nd₂Zr₂O₇ and at least RETH such as Gd and Eu have thermal expansion in the region of interest (see FIG. 1) and other RETH earth cation zirconates and stannates and their solid solutions (including La, Y and Sc) also have useful thermal expansion coefficients. In FIG. 1 circles represent YSZ, squares represent Neodymium zirconate, stars represent Gadolinium zirconate, plusses (+) represent Lantinum zirconate and inverted triangles represent Europium zirconate. FIG. 2 illustrates the high electronic plus ionic resistivity that can be found in these compounds. In FIG. 2 dark circles correspond to 10⁻³ bar oxygen, and white circles to 1 bar oxygen.

In another aspect the pyrochlore is M₂Ti₂O₇, wherein M is Sc, Y, La, and all lanthanides except Pm.

The terminology for perovskite and distorted perovskite crystal structure and superstructure of perovskite is from A. F. Wells, “Structural Inorganic Chemistry,” Fourth edition, Clardon Press, Oxford, 1975, pg. 486. Perovskite and distorted perovskite crystal structure and superstructure of Perovskite compositions and synthesis of such compositions and other compositions for use in this invention can be found in Wells, “Structural Inorganic Chemistry,” cited above and in Francis S. Galasso, “Structure, Properties, and Preparation of Perovskite Type Compounds,” Pergamon Press, 1969, both references are herein incorporated by this reference in their entireties and for their teachings of such compositions.

Some perovskites have high expansions, although most have been studied for their dielectric properties for use in capacitors in electronics at near room temperature. In one aspect, they are Ba(Sr)Zr(Hf)O₃ or Ba(Sr){Mg_{1/3}Ta(Nb)_{2/3}}O₃. The oxides of Ba, Sr, Mg, Zr, Hf and Ta are not easily reduced so high electrical resistivity are achieved at high temperatures even in moderately reducing environments.

In another aspect, perovskite composition family's based on BaTiO₃, SrTiO₃, Bi₄Ti₃O₁₂, or Al₂TiO₃ are included. Bi₄Ti₃O₁₂ can have a room temperature resistivity of greater than 10⁸ to 10¹² ohm-cm for a deposited film. For compositions containing titanium oxide and particularly for the bismuth oxide containing compositions, the materials can preferably be used on the air/cathode side of the fuel cell to avoid reduction of the titanium oxide/bismuth oxide. Aluminum titanate (Al₂TiO₃) has a very anisotropic thermal expansion coefficient and can microcrack heavily at large grain sizes. With perovskite, distorted perovsike and distorted pyrochlores with anisotropic thermal expansion coefficients, deposition and sintering techniques which keep the grain size small are preferred. Grain sizes under 5 microns and more preferably under 1 microns are preferred for materials with highly anisotropic thermal expansion coefficients.

In one aspect, fluorite crystal structures and distorted fluorite crystal structures (tetragonal structures) are of particular interest. Zirconia and hafnia based materials with fluorite/distorted fluorite crystal structures can be made with very low oxygen vacancy concentrations. The low vacancy concentration reduces very substantially the oxygen ion conduction without increasing electronic conduction. One method to achieve this is to use zirconia (or hafnia) and Y(RETH)TaO₄ and/or Y(RETH)NbO₄ to form ceramic solid solutions and alloys with tetragonal and tetragonal prime phases (slightly distorted fluorite crystal structures). These phases can have very low oxygen ion conductivity and low electronic conductivity while maintaining the relatively high thermal expansion coefficients of the zirconia (hafnia) base material.

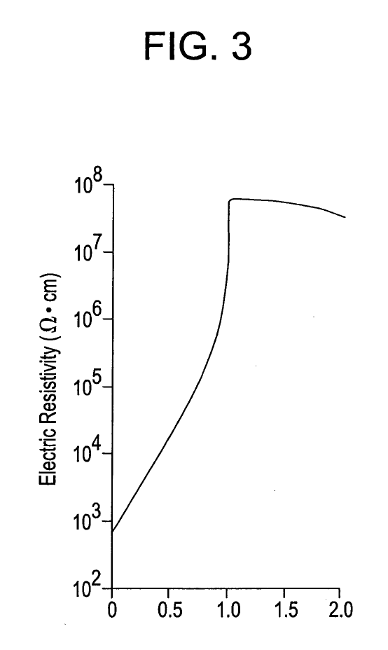

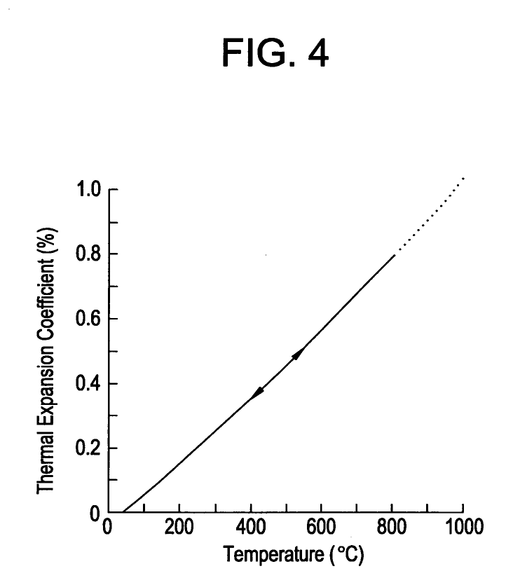

FIG. 3 shows the total resistivity as a function of the molar ratio of (M⁵⁺cations +2×M⁶⁺ cations)/(M³⁺ cations+2xM²⁺cations). The thermal expansion coefficient of these materials is also within 9×10⁻⁶/° C. to 15×10⁻⁶/° C. as shown in FIG. 4, where the data has been extrapolated from 800° C. to 1,000° C. With these fluorite systems, alloying with CaWO₄, MgMoO₄ and other combinations and permutations of +2, +6 and +3, +5 cations such as Ca, Mg, W, Mo, V, Sc, Y, and Re and +4 cations such as TiO₂, SnO₂ and CeO₂ can be useful. The goal is to have a minimum of oxygen vacancies yet avoid transformation to the monoclinic phase, as the transformation from a tetragonal phase to monoclinic phase usually involves generation of cracks which would compromise the insulation ability of the layer or coating. This phase transformation also reduces the effective thermal expansion coefficient due to the volume expansion. In the situation where the coating or layer is exposed to very reducing atmosphere, (i.e. raw fuel), the effect of the reduction on any variable valance cation as is listed above should be measured and insure that the alloy/compound does not become an ionic or electronic conductor due to the reduction.

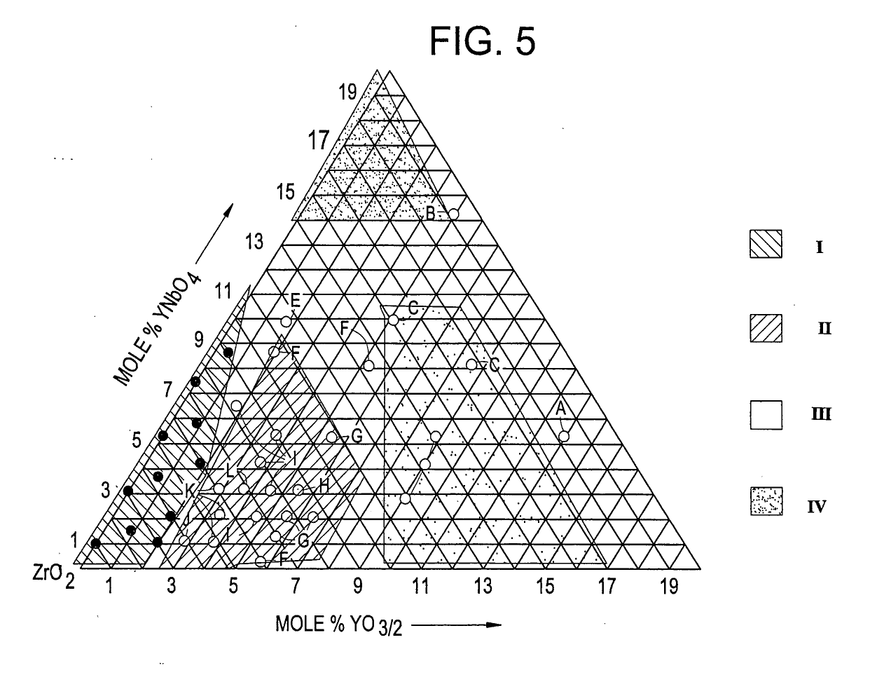

FIG. 5 shows an approximate phase diagram at 1400-1500 C of the ZrO₂ (HfO₂)—Y(RETH)Nb(Ta)O₄—Y₂O₃(RETH₂O₃) system (where RETH is a rare earth element in cation form, including Y and Sc) based on room temperature toughness measurements along with x-ray diffraction, and electron diffraction (for a small number of compositions), naked eye, optical microscopic, SEM and TEM observations. The preferred compositions in this system for the purpose of electronic and ionic insulation are those along and near the ZrO₂—YTa(Nb)O₄ join that have a atomic ratio of +5 cations to +3 cations greater than 0.5 and preferably greater than 0.8, more preferably 0.9 and most preferably 1.0 or greater. The tetragonal prime phase and tetragonal phase, both distorted fluorite structures are the major crystal structure in this composition range. When the alloy contains +6 and +2 cations as well, the ratio is 2×atomic % of +6 cations +atomic % of +5 cations divided by 2× the atomic % of +2 cations+the number of +3 cations. It is desirable to achieve maximum toughness without microcracking. In FIG. 5 the dark circles correspond to microcracked and light (unfilled) circles correspond to the unmicrocracked system. The letters A through L correspond to fracture toughness of 2 through 17, respectfully, where fracture toughness is (K_{1C}) in MPa m^{1/2}, rounded to the nearest whole number for the given composition(s). The different shaded areas of FIG. 5 indicate phase of the system (ZrO₂—YNbO₄—YO_{3/2}), at room temperature, after sintering at 1300-1600° C., where: symbol I indicates that material is tetragonal after sintering and converts to monoclinic on cooling to room temperature; symbol II indicates that material is tetragonal at room temperature; symbol III indicates that material is a mixture of tetragonal and cubic at room temperature; and symbol IV indicates that material is primarily cubic at room temperature.

The invention includes insulating fluorite (distorted fluorite) crystal structure containing compounds with thermal expansions in various aspects of 8×10⁻⁶ to 16×10⁻⁶ C, 9.0×10⁻⁶ to 15×10⁻⁶/C, or 9.5×10⁻⁶ to 14.5×10⁻⁶/C. In another aspect, insulating fluorite (distorted fluorite) containing compositions with resistivities higher than 100 ohm-cm are used with resistivities higher than 1,000 ohm-cm more and resitivities even greater than 10,000 ohm-cm. In another aspect, the fluorite major phase is tetragonal or tetragonal prime (un-transformable tetragonal).

In further specific embodiments, examples of compositions are Nd(RETH)₂Zr₂O₇, Nd(RETH)₂Sn₂O₇, Ba(Sr)Zr(Hf)O₃, Ba(Sr){Mg_{1/3}Ta(Nb)_{2/3}}O₃, BaTiO₃, SrTiO₃, B4Ti₃O₁₂, aluminum titanate and Zr(Hf)O₂—Y(RETH)Ta(Nb)O₄ composition families.

In other aspects, the insulating oxide ceramic comprises RETHZr₂O₇, RETHSn₂O₇, Ba(Sr)Zr(Hf)O₃, Ba(Sr){Mg_{1/3}{Ta(Nb)_{2/3}}O₃, Ba(Sr)TiO₃, Bi4Ti₃O₁₂, Al₂TiO₃, or ZrO₂—HfO₂ with RETH (Mg or Ca)Ta(Nb)O₄. In other aspects, the insulating oxide ceramic comprises Nd(RETH)₂Zr₂O₇, Nd(RETH)₂Sn₂O₇, Ba(Sr)Zr(Hf)O₃, Ba(Sr){Mg_{1/3}Ta(Nb)_{2/3}}O₃, BaTiO₃, SrTiO₃, Bi₄TiO₁₂, Al₂TiO₃, Zr(Hf)O₂—Y(RETH)Ta(Nb)O₄, La₂Zr₂O₇, Nd₂Zr₂O₇, Gd₂Zr₂O₇, Eu₂Zr₂O₇, Y₂Zr₂O₇, or Y₂Sn₂O₇, where RETH is a rare earth element including Y and Sc.

In another aspect, the insulating composition can comprise Nd(RETH)₂Zr₂O₇ and Zr(Hf)O₂—Y(RETH)Ta(Nb)O₄ composition families, where RETH denotes rare earth cations, including Y and Sc.

In other aspects, the insulating composition can comprise RETHZr₂O₇, RETHSn₂O₇, or mixtures thereof. In other aspects, the insulating composition can comprise ZrO₂—HfO₂ with RETH (Mg or Ca)Ta(Nb)O₄. In other aspects, the insulating composition can comprise Ba(Sr)Zr(Hf)O₃ or Ba(Sr){Mg_{1/3}{Ta(Nb)_{2/3}}O₃.

In another aspect, the ordered anion defective fluorite can be Zr₅Sc₂O₁₃.

The insulating compositions of the invention can be combined with well know high temperature insulators, such as alumina and magnesium aluminate spinel, at volume fractions of the insulating compositions of the invention of, for example, from about 25% to about 95 vol. %, or from about 45% to about 95 vol. %, to increase the thermal expansion coefficient to better match the CTE of the frame, while maintaining the composite materials insulating properties.

Second phases such as alumina are often used in ceramics whose main phase is fluorite crystal structure as a grain growth inhibitor or a toughening agent. For some compositions with primary phases of pyrochlores and perovskites, alumina and other oxides can be used as grain growth inhibitors or as toughening agents. In one embodiment, up to 5 volume % of a second phase oxide insulating phase is used.

In one embodiment, the insulation compositions of the invention can have thermal expansion coefficients of from 8.0 to 16.0×10⁻⁶/° C. from room temperature-1000° C., in another aspect from 9×10⁻⁶ to 15×10⁻⁶/° C. and in another aspect from 9.5×10⁻⁶ to 14.5×10⁻⁶/° C. The insulating compositions can restrict both electronic and ion conduction. The insulation systems can have low electronic and ionic conduction in at least in air, and in another aspect, in both air and reducing environments, at temperatures of from about 500 to 1000° C.

In various aspects, the insulating composition has a resistivity of at least 10 ohm-cm, at least 100 ohm-cm, at least 1,000 ohm-cm, or at least 10,000 ohm-cm. In various aspects, the insulating composition has an area specific resistance of at least 10 ohm-cm², at least 100 ohm-cm², at least 1,000 ohm-cm², or at least 10,000 ohm-cm². Such resistivities can be found in both high oxygen activity and somewhat reducing environments.

The compositions of the invention are commercially available or are readily synthesized. For a general synthesis, see for example, A. F. Wells, “Structural Inorganic Chemistry,” Fourth edition, Clardon Press, Oxford, 1975 and Francis S. Galasso, “Structure, Properties, and Preparation of Perovskite Type Compounds,” Pergamon Press, 1969.

Depending upon the problem to be solved by the use of the insulating oxide and the geometry of how the material is used, the line resistance or aerial resistance of the layer or region can be a design consideration. Thin layers on electrically conducting frames for example may need to have an area specific resistance of greater than 10,000 ohms-cm² to prevent seal degradation, while insulators as a coating or as an insulating region in an electrolyte used to prevent power loss may only need a resistivity of about 10 ohm-cm or an area specific resistance of 10 ohm-cm². Regions in the electrolyte sheet that electronically and ionically isolate the cells on the sheet can have a lower resistance for a power loss use, but may need a high resistance to prevent current flow and seal degradation over the extended times, thousands to perhaps tens of thousands of hours, the lengths some commercial SOFC systems are expected to operate.

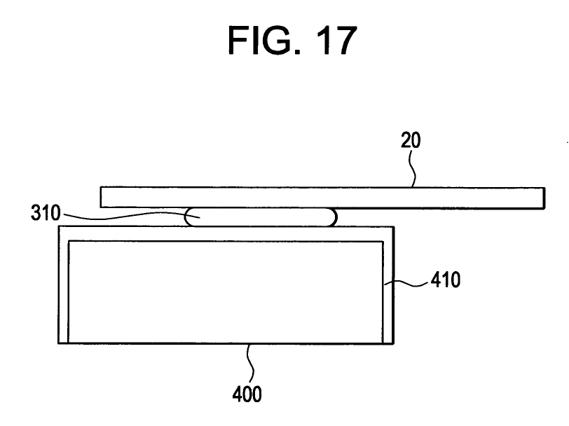

The geometry of the insulating material multiplied by the resistivity of the material leads to the resistance per length or area. For prevention of seal degradation, in certain aspects, a resistance of 10,000 ohms-cm² may be desired. Table I below shows what combinations of resistivity and thickness can lead to an areal resistance of greater than 10 ohm-cm² (single asterisk) or even greater than 10,000 ohms-cm² (double asterisk). The asterisks in the table indicate the acceptable range depending on the use for certain aspects of the invention. It differs for each use, with the metal coatings being the most stringent. For reducing power loss, relatively thin coatings, on the order of 100 microns and materials with resitivities of 1,000 ohm-cm at the operating temperature can be employed (see single asterisked combinations). For the more stringent goal of reducing seal degradation, thicker coatings and or more resistive materials need to be used (see double asterisked combinations). See FIG. 17 for an example of these aspects.

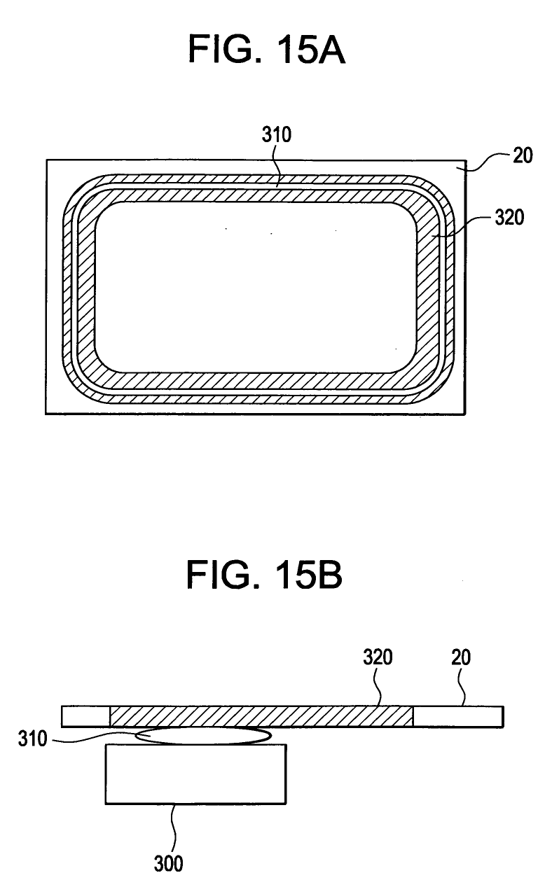

For preventing power loss or material degradation to the seal when using insulating oxides through the thickness of the electrolyte, a wide variety of material resisitives may be employed, due to the slight thickness of the electrolyte. For an example of this, see FIGS. 15a and b and 16a and b. Table II below shows the linear resistance expected at length scales appropriate between cell/via pads and cell. Table III below shows the linear resistance expected at larger length scale appropriate for the street widtk region of electrolyte between the cells and the seal. For the purposes of the calculation in Tables II and III, the electrolyte (and insulating region thickness) is assumed to be 20 microns thick. For Tables II and III, single asterisk denotes 10 cm-ohm or higher and a double asterisk denotes 10,000 cm-ohm or higher.

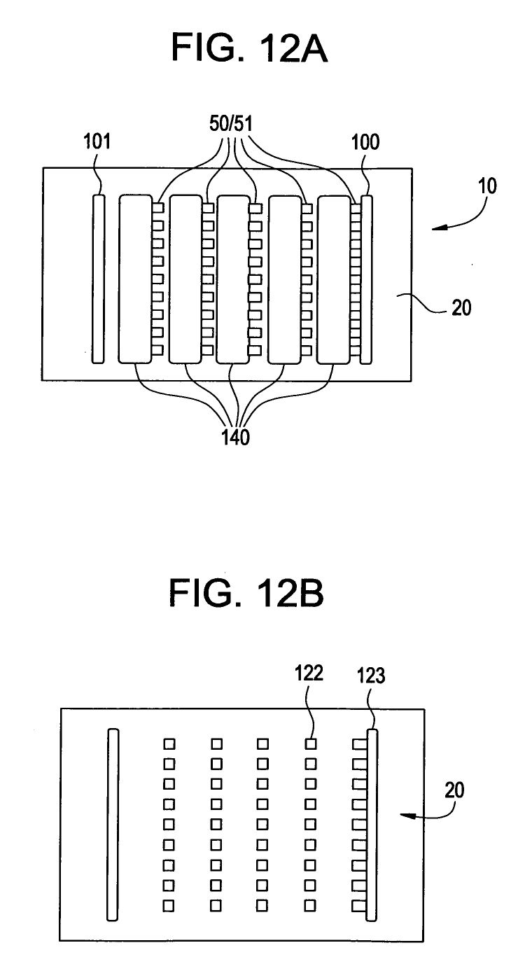

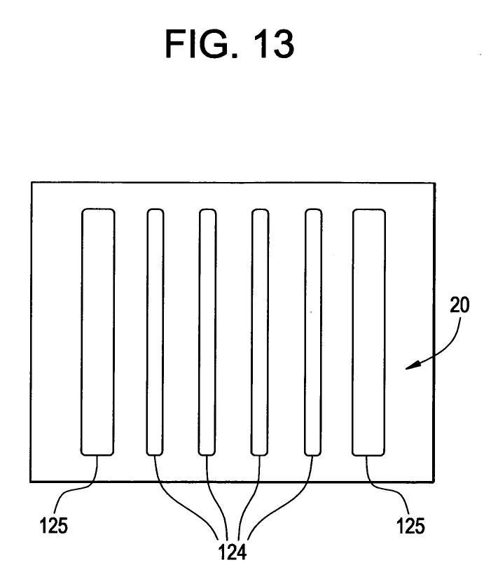

For prevention of power loss between electrodes in multiple cell devices, a resistance of about only 10 ohms-cm may suffice. See, for example, FIG. 13 for this aspect. Table III shows the combinations of resistivity, thicknesses and separation distance to achieve this resistance. When the inventive materials are used through the thickness to prevent power loss or seal degradation, lower resistivity materials can be used. For a coating on an electrolyte of only 1-25 microns in thickness, the higher resistivity materials are desirable, particularly for the 10,000 ohm-cm² criteria as shown in Table IV below. Table IV below shows what combinations of resistivity and thickness can lead to an areal resistance of greater than 10 ohm-cm² (single asterisk) or even greater than 10,000 ohms-cm² (double asterisk). For reduction of the power/efficiency loss associated with via-region short-circuiting, a resistive layer of about 10 ohm-cm² or more will essentially eliminate the problem. Such layers may be easily introduced under each via pad. An example of such a printed pattern shown in FIG. 12b.

For under the via pad or bus bar or in the via gallery, in one aspect, the thickness is from 0.1 micron to 100 microns, in another aspect from 1 to 10 microns. For the frame coatings, in one aspect, the thickness is from 1 to 1000 microns, in another aspect from 10 to 100 microns. For prevention of power loss via insulating oxides through the thickness of the electrolyte, in one aspect, the width of diffused area (path length) is from 0.05 cm to 5 cm and in another aspect is from 0.2 cm to 1 cm.

TABLE I
Areal resistance for a coating, in ohm - cm²

| Coating | Material resistivity ohm -cm | | | | |
|---|---|---|---|---|---|
| thickness, cm | 100 | 1,000 | 10,000 | 100,000 | 1,000,000 |
| 0.01 | 1 | *10 | *100 | *1,000 | **10,000 |
| 0.05 | 5 | *50 | *500 | *5,000 | **50,000 |
| 0.1 | *10 | *100 | *1,000 | **10,000 | **100,000 |
| 0.5 | *50 | *500 | *5,000 | **50,000 | **500,000 |
| 1 | *100 | *1,000 | **10,000 | **100,000 | **1,000,000 |
| 2 | *200 | *2,000 | **20,000 | **200,000 | **2,000,000 |

TABLE II
Linear resistance in ohm - cm, length scales
appropriate for cell/via gallery spacing

| Insulation region | Material resistivity ohm -cm | | | | |
|---|---|---|---|---|---|
| length, cm | 100 | 1,000 | 10,000 | 100,000 | 1,000,000 |
| 0.001 | *50 | *500 | *5,000 | **50,000 | **500,000 |
| 0.005 | *250 | *2,500 | **25,000 | **250,000 | **2,500,000 |
| 0.01 | *500 | *5,000 | **50,000 | **500,000 | **5,000,000 |
| 0.025 | *1,250 | **12,500 | **125,000 | **1,250,000 | **12,500,000 |
| 0.05 | *2,500 | **25,000 | **250,000 | **2,500,000 | **25,000,000 |

TABLE III
Linear resistance in ohm - cm, length scales appropriate
for insulating street width spacing

| | Material resistivity ohm -cm | | | | |
|---|---|---|---|---|---|
| Length, cm | 100 | 1,000 | 10,000 | 100,000 | 1,000,000 |
| 0.1 | *5,000 | **50,000 | **500,000 | **\grave{ }5,000,000 | **50,000,000 |
| 0.5 | **25,000 | **250,000 | **2,500,000 | **25,000,000 | **250,000,000 |
| 1 | **50,000 | **500,000 | **5,000,000 | **50,000,000 | **500,000,000 |
| 2 | **100,000 | **1,000,000 | **10,000,000 | **100,000,000 | **1,000,000,000 |

TABLE IV
Areal resistance in ohm - cm²

| | |
|---|---|
| Thickness, | Material resistivity ohm -cm |

| cm | 100 | 1,000 | 10,000 | 100,000 | 1,000,000 |
|---|---|---|---|---|---|
| 0.001 | 0.1 | 1 | *10 | *100 | *1,000 |
| 0.005 | 0.5 | 5 | *50 | *500 | *5,000 |
| 0.01 | 1 | *10 | *100 | *1,000 | **10,000 |
| 0.025 | 2.5 | *25 | *250 | *2,500 | **25,000 |

In one aspect, the insulating composition is proximate to the bus bar and/or via pad. In another aspect, the insulating composition is in contact with the bus bar and/or via pad. In another aspect, the insulating composition is in contact with the electrolyte. In another aspect, the insulating composition is in contact with the bas bar and the electrolyte.

In another aspect, the insulating composition is in contact with the via pad and the electrolyte. In another aspect, the insulating composition is in contact with two or more via pads and the electrolyte. In another aspect, the insulating composition is a continuous layer in contact with two or more via pads and the electrolyte.

In another aspect, the insulating composition is present in part of the electrolyte. That is, the insulating composition forms part of the electrolyte sheet. In this aspect, the insulating composition can be present across part of the diameter in part of the electrolyte or it can be present across the entire diameter in part of the electrolyte. In another aspect, the insulating composition is present in part of the electrolyte and is present in at least one discrete section. In another aspect, the insulating composition is present in part of the electrolyte and is proximate the seal. In another aspect, the insulating composition is present in part of the electrolyte and is in contact with the seal. In another aspect, the insulating composition is present in part of the electrolyte and is not in contact with the seal. In another aspect, the insulating composition is present in part of the electrolyte and is between the electrode and the seal.

In another aspect, the insulating composition is under the via pads, over the electrolyte in the via gallery, through the electrolyte in the via gallery, under the bus bar, or through the electrolyte under the bus bar. In this aspect, in one embodiment, the insulating composition can extend up to 5 mm past these features on the electrolyte with a multi-cell design.

In another aspect, the insulating composition is adjacent to and in contact with the frame. In this aspect, the insulating composition can be disposed between the frame and the seal, wherein the seal is disposed between the insulating composition and the electrolyte.

In yet another embodiment, the insulating composition is not in contact with the cathode and/or anode.

The insulation composition, layers, and coatings can be used in any fuel cell device in the art. Fuel cell designs are well known to those of skill in the art. Representative examples of a fuel cell device for which the insulation of the present invention can be readily applied is found in U.S. Pat. No. 6,623,881 to Badding et al., U.S. Pat. No. 6,630,267 to Badding et al., and U.S. Pat. No. 6,852,436 to Badding et al., which are all herein incorporated by this reference in their entireties and are all incorporated by this reference specifically for the teaching of the configuration of a fuel cell device.

In a typical configuration of a SOFC herein, the electrolyte is disposed between the anode and the cathode, the anode of one fuel cell is electrically connected to the cathode of another fuel cell by a via pad at the anode and a via pad at the cathode, the via pads are electrically connected to each other with a via fill that traverses through the electrolyte, the bus bar is electrically connected to the electrode at each end of the electrolyte, and the seal is disposed between the electrolyte and a frame adjoining the seal. Typically, the seal is in contact with the electrolyte (or the insulation portion of the electrolyte). In one aspect, the seal is in contact with the frame, and in another aspect, the seal is not in contact with the frame. When not in contact with the frame, the seal can instead be in contact with, for example, the insulation layer on the frame as in FIG. 17. In one aspect, the electrolyte is an unsupported, free standing sheet. The electrolyte thickness is typically ≦30 μm, such as from 4 μm to 30 μm. Maintaining total internal fuel cell resistances at values less than 1 ohm-cm², or even below 0.6 ohm-cm², at designed operating temperatures is important, and to achieve such values the electrical resistance of the electrolyte sheet should be less than 0.5 ohm-cm², preferably less than 0.3 ohm-cm². For conventional oxygen-ion-conducting electrolytes this means that, depending on cell operating temperature, sheet or plate thickness will generally be below 1 mm, with sheet thicknesses in the 100-500 μm range being preferred where the electrolyte is to impart some structural rigidity to electrode/electrolyte structure.

The electrolyte, anode, and cathode materials can be those typically used in the art. In various non-limiting examples, those materials are as disclosed in U.S. Pat. No. 6,623,881 to Badding et al., U.S. Pat. No. 6,630,267 to Badding et al., and U.S. Pat. No. 6,852,436 to Badding et al., which patents are al herein incorporated by this reference for all of their teachings as well as specifically for their teachings of the electrolyte and electrode materials. For example, in one embodiment, the electrolyte is 3YSZ, the cathode catalyst is LSM/YSZ, the cathode current collector is Ag—Pd/ceramic, the anode catalyst is Ni/YSZ, and the anode current collector is Ag—Pd/ceramic. This invention is not limited to these and may apply to doped ceria and gallia based electrolytes and compounds of such, such as gadolinium doped ceria and lanthanum gallate, and electrode compositions found to be useful for those electrolytes known to those skilled in the art.

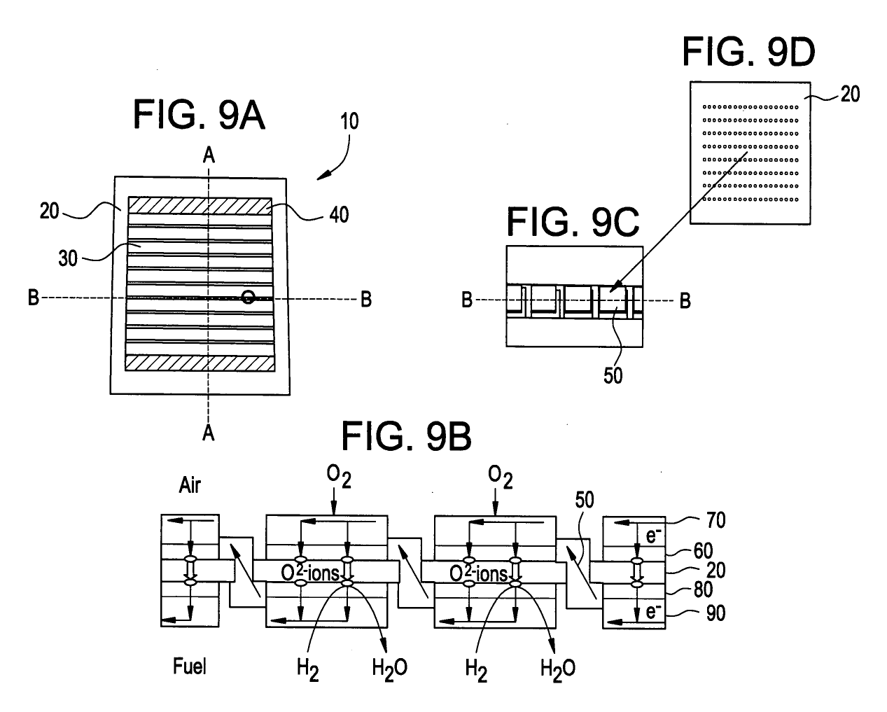

Referring to FIG. 9a, which is one embodiment of the invention, a fuel cell sheet or device is shown (10). The sheet or device contains 10 fuel cells. The fuel cell device comprises an electrolyte sheet (20) and an electrode cell (30). The electrode cell (30) is contained on each side of the electrolyte sheet (20). The bus bars are shown at (40) and the metal filled via current path at (50). A blow up of the metal filled via current path is shown in FIG. 9c. The electrolyte sheet showing the via holes that contain the vias are shown in FIG. 9d.

FIG. 9b is an overall representation of a typical fuel cell device of the invention. The electrolyte (20) is disposed between the cathode or cathode catalyst layer (60) and anode or anode catalyst layer (80) and the cathode (60) is in contact with the cathode current collector (70) and the anode (80) is in contact with the anode current collector (90). Oxygen typically from air enters the cathode current collector (70) and exits the anode current collector (90) after reacting with hydrogen in the fuel to form water.

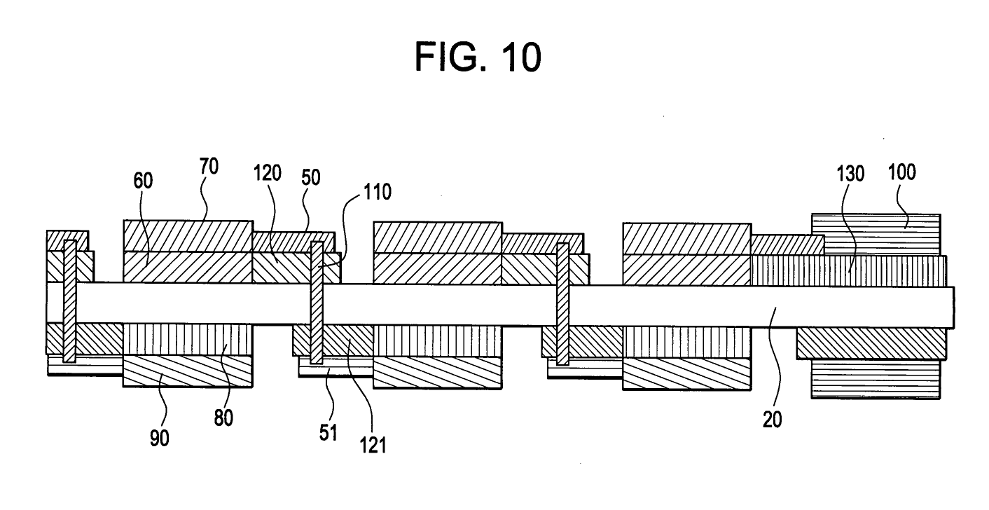

FIG. 10 is a side view of cut line A-A of FIG. 9a. The electrolyte (20) is shown in electrical communication with the cathode catalyst layer (60), cathode current collector (70), anode catalyst layer (80), and anode current collector (90). Additionally, the bus bar (100) is shown at one end of the fuel cell in electrical communication with the cathode current collector (70). The metal filled via (110) connects each of the via pads (50) and (51) so that current can flow from the anode current collector of one cell (90) to the cathode current collector (70) of the next cell. The insulating layer of one embodiment of the invention is shown at (120), (121), wherein the insulating layer (120) and/or (121) is disposed between the via pad (50) and/or (51) and the electrolyte (20). In another embodiment, the insulating layer (130) is disposed between the bus bar and the electrolyte (20).

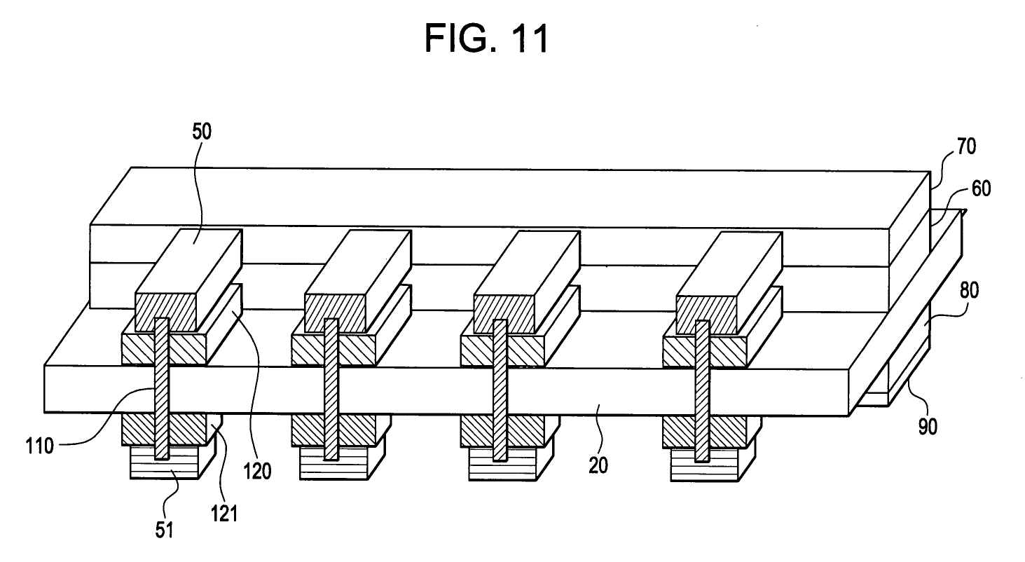

FIG. 11 is a cross sectional view taken along cut line B-B of FIG. 9a. The cathode (60), cathode current collector (70), anode (80), anode current collector (90), and electrolyte (20) are all shown with similar representation as in FIG. 10. The metal filled via (110) is connected from one via pad (50) to another via pad (51) through the electrolyte (20). The insulating layers (120) and (121) in one embodiment are shown between the via pad (50) and electrolyte (20) and via pad (51) and electrolyte (20).

FIGS. 12a and 12b show approximate locations for the insulating composition for one aspect of the invention. Specifically, in FIG. 12a, the fuel cells are shown as one unitary system (10), containing the electrolyte sheet (20), the via pads (50), (51), bus bars (100), (101), and electrodes (140). FIG. 12b shows the approximate locations for the area for the insulating layers under the via pad (122) and bus bar (123), respectively, extending out slightly. A similar pattern but reversed can be on either side of the electrolyte (20).

FIG. 13 shows another embodiment of the invention where the insulating regions or layers are shown in the via galleries (124) as a uniform layer on the electrolyte sheet (20) and under the bus bar (125). A similar pattern can be reversed on the other side of the electrolyte (20).

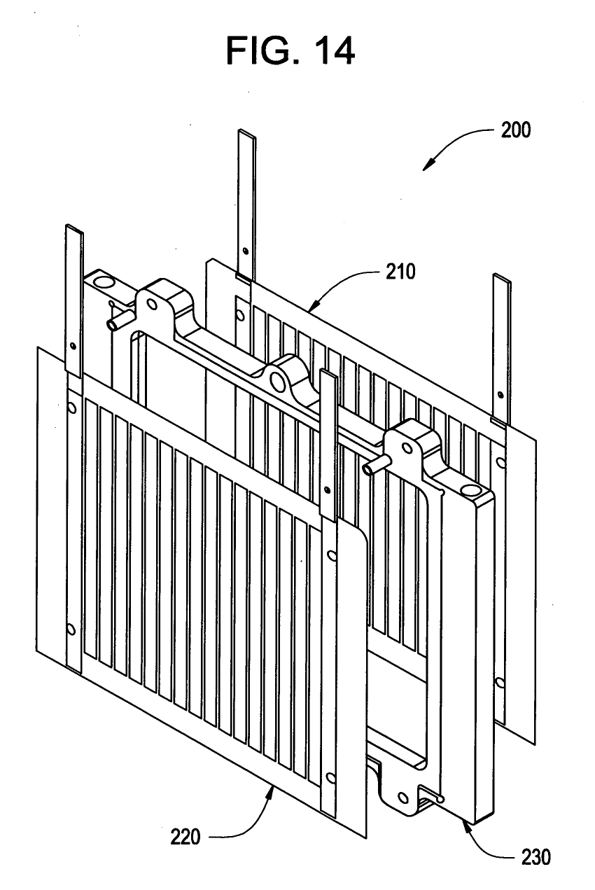

FIG. 14 shows another aspect of the invention comprising a frame assembly (230) with two fuel cell devices (210), (220) to form a packet (200) of one embodiment of the present invention. The frame can be made of a variety of materials, such as those used in the art, for example, metallic compositions such as stainless steel. The fuel cell devices (210), (220) are fixed to the frame (230) by any seal, such as one typically used in the art, such as for example, glass or glass ceramic seals.

FIG. 15 shows another embodiment of the present invention. In this embodiment part of the electrolyte (20) is made of the insulating material. In FIG. 15b, the frame (300), seal (310), and electrolyte (20) are shown. The part of the electrolyte (20) formed from the insulating material is shown as (320). The insulating material in the electrolyte (20) can be across the entire diameter of the electrolyte thickness as shown in FIG. 15b or may only traverse part of the diameter of the electrolyte (20) (not shown). FIG. 15a is a top level view of the FIG. 15b configuration, showing the electrolyte (20), the sealed region (310), which forms a race track type configuration adjoining the frame (300) to the electrolyte (20). The insulating region within the electrolyte (320) is shown. The electrode (not shown) in FIG. 15b is to the right of the insulating region (320), and therefore, the insulating region (320) is disposed between the electrode and the seal (310).

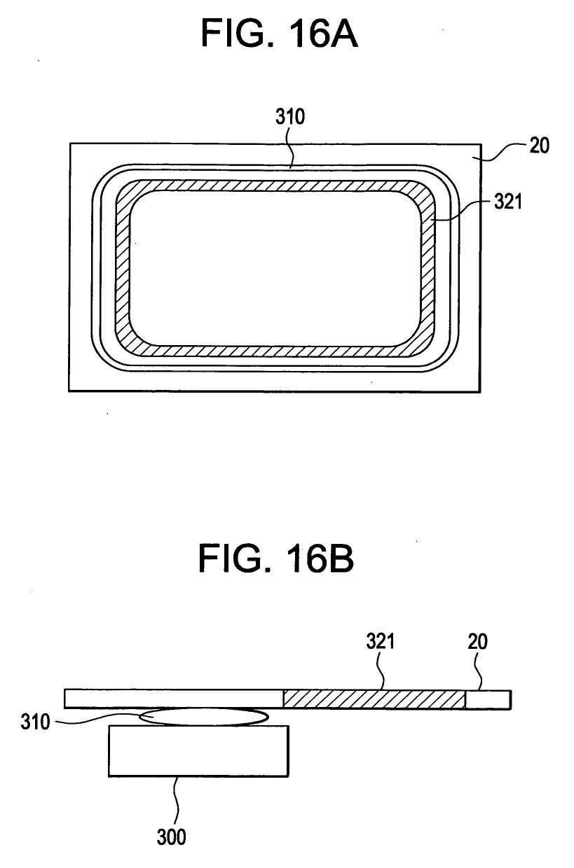

FIG. 16 is another embodiment of the invention, and shows a configuration similar to FIG. 15b except that the insulating region (321) is displaced away from the seal region (310) and is not in contact with the seal (310). The electrode (not shown) in FIG. 16b is to the right of the insulating region (321), and therefore, the insulating region (321) is disposed between the electrode and the seal (310).

FIG. 17 shows yet another embodiment of the invention. Here the frame (400) is joined to the electrolyte (20) with a seal (310). An insulating coating (410) is disposed between the seal (310) and the frame (400). The insulating coating can extend about the width of the seal (310) (not shown) or further outside of the seal (310), up to and including around the frame (400) as shown in FIG. 17.

The fuel cell can be part of a sheet or device, which in turn can be combined with another sheet or device to form a packet, which packet in turn can be combined with other packets to form a stack. Such a stack can be part of a larger fuel cell system. In one aspect, there are at least two cells on the electrolyte.

The insulating composition is typically applied to the electrolyte below or adjacent to the bus bar and via pads by screen printing, although other methods are applicable. Thicker layers are possible and thinner layers are possible with other coating methods, such as ink jet, photolithography, e-beam deposition, sputtering, CVD, sol gel, PVD, etc. The insulating materials of the invention can be used in SOFC systems as coatings on conducting frames, applied by a variety of means including plasma spraying, e-beam deposition, electrophoresis, sol-gel coating, slurry coating, etc. For a solid oxide fuel cell wherein the insulating composition is present in part of the electrolyte and optionally the insulating composition is present across part of the diameter or the entire diameter in part of the electrolyte, a coating may be applied to the pre-fired electrolyte and the insulating material in the insulating area may be formed by diffusion of coating constituents into the electrolyte or by interdiffusion between the coating constituents and the electrolyte. Alternately, the material may be applied to the unfired electrolyte, and diffused to form the insulating region.

In one aspect, to make a useful patterned insulating layer, such as, for example a rare earth zirconate, on a zirconia electrolyte, a rare earth oxide or oxide precursor is patterned on the surface of the electrolyte and the oxide reacts at high temperature to form an insulating pyrochlore phase.

The compositions of the invention can be used in SOFC systems as coatings on conducting frames to prevent power loss and electrochemical degradation of the seal, on or through the electrolyte to prevent power loss between cells in systems with a single or multiple cell device on a single electrolyte as well as preventing stray electrochemical reactions that can degrade the materials. These compositions can be used on or through the electrolyte to prevent power loss from the active region (with the electrodes) to the frame as well as electrochemical reactions degrading the materials, particularly the seal.

The insulating materials of the invention can be used in SOFC systems as coatings on conducting frames. Such coatings are particularly useful when the fuel cell design includes multiple cells on one electrolyte sheet, as considerable voltages can be generated at the seal by such a design. While intended as an electrically insulating coating, if the coating covers all or the majority of a metal frame surface, when the metal contains Cr, the coating can also act to prevent Cr migration to the cathodes of the fuel cell and reduction of fuel cell electrode performance. When the coating is nearly matched in thermal expansion to the frame, the coating's thickness can be quite large, such as for example, 250 microns, 500 microns, or even up to 1 mm.

The composition families can also be used on the electrolyte sheet as insulating layers. Areas of the electrolyte sheet that can employ these insulating composition layers are the perimeter of the sheet between the ion conducting electrolyte sheet and the seal material and underneath the bus bars and under the via pads or in the via galleries in a multi-cell device design as shown in FIGS. 12a and 12b and 13.

The insulation compositions of the present invention have improved mechanical strength, decreased mechanical failure, and/or an improved CTE match to the frame of the packet. This invention can be used as a coating material on a conducting frame in a variety of thicknesses, as the inventive compositions can have a better thermal expansion match to the frame materials than alumina. The insulating structures will not react with glasses and glass ceramic seals as easily as the magnesia in the magnesium aluminate spinel plus magnesia coating of the prior art.

The insulating oxide materials can be used as coatings on the electrolyte. When the expansion coefficient and sintering properties are matched well enough, the materials can also be used as part of the electrolyte, even through the entire thickness in some regions of the electrolyte. The inventive compositions can also be used as a reaction barrier layer between other insulating coatings such as magnesium aluminate spinel plus magnesia and glass seals to prevent reaction with the seal material. As magnesium aluminate spinel plus magnesia is a very inexpensive material, a reaction barrier layer of the inventive insulating non-reactive oxides on magnesium aluminate spinel plus magnesia can be an attractive composite insulating coating/material.

The compositions of this invention also have a CTE advantage over prior insulation compositions. This is due in part to the thermal expansion coefficient of alumina (about 88×10⁻⁷/C) being quite different than the expansion of the frames and electrolyte, (about 105 to 125×10⁻⁷/C), inducing stresses in the plasma sprayed alumina (PSA) layer on thermal cycling, whereas the compositions of the present invention are well matched to the CTE of the frames and electrolyte.

Although several aspects of the present invention have been described in the detailed description, it should be understood that the invention is not limited to the aspects disclosed, but is capable of numerous rearrangements, modifications and substitutions without departing from the spirit of the invention as set forth and defined by the following claims.

### EXAMPLES

To further illustrate the principles of the present invention, the following examples are put forth so as to provide those of ordinary skill in the art with a complete disclosure and description of how the compositions, articles, devices, and methods claimed herein are made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations should be accounted for. Unless indicated otherwise, temperature is ° C. or is at ambient temperature, and pressure is at or near atmospheric. There are numerous variations and combinations of process conditions that can be used to optimize product quality and performance. Only reasonable and routine experimentation will be required to optimize such process conditions.

### Example 1

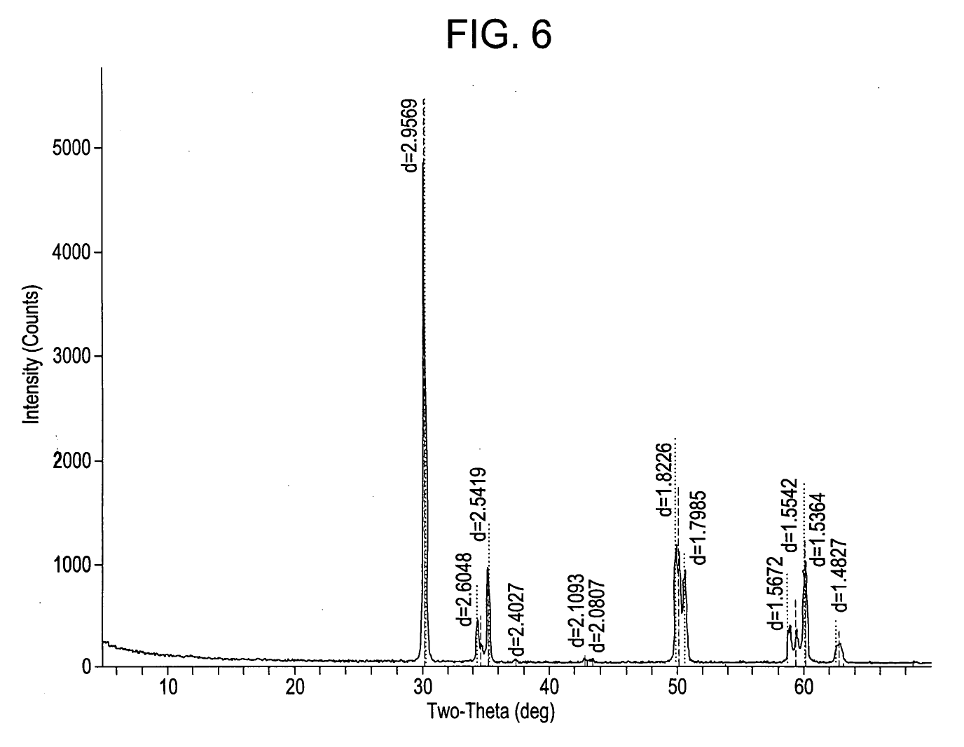

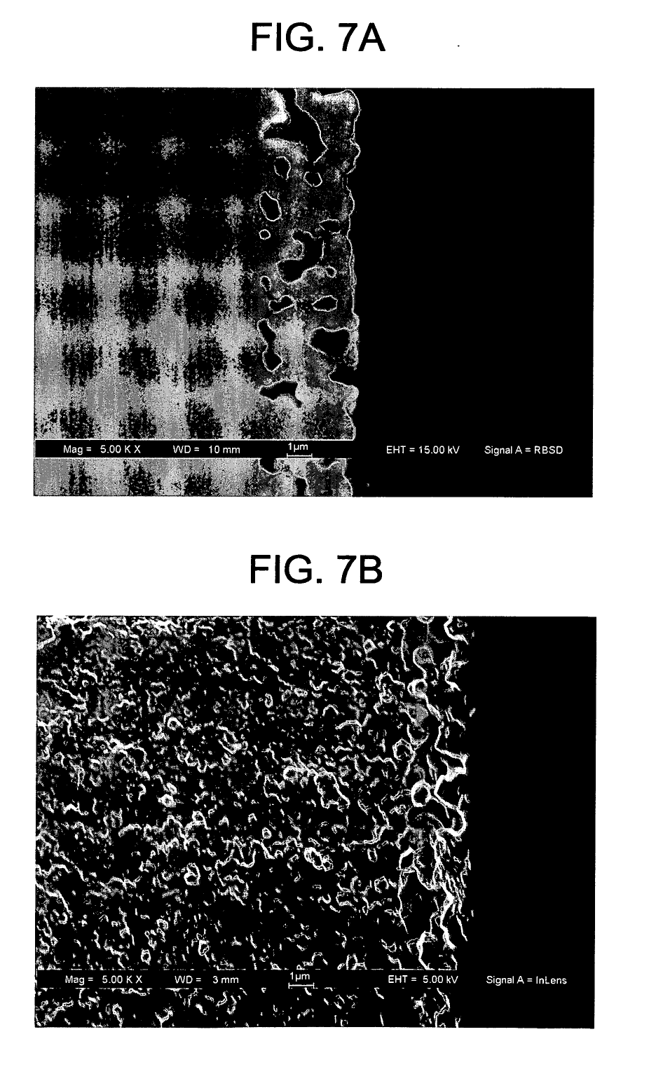

ZrO₂ with approximately 16 mole % YTaO₄ and approximately 0.5 mol % Ta₂O₅ composition, was made and applied to a zirconia-3 mole % yttria electrolyte. The yttrium tantalate doped zirconia composition has a distorted fluorite structure, T′ (tetragonal prime) phase, as its major phase. Zirconia-8 mole % yttria powder, Tosho TZ-8Y, was vibro-milled with the appropriate amount of Ta₂O₅ for several days using ethanol as a fluid and using Tosho TZ3Y milling media. The powder was dried and calcined at about 120° C. for several hours in air. The powder was vibro-milled a second time for 24 hours. After drying, NiO was added as a sintering aid at the <5 wt % level and the powder made into inks using a three roll mill. The composition was screen printed onto zirconia 3-mole % yttria electrolyte and the sample dried, then fired at about 1400° C. for several hours in air. The phases in the sample were identified by x-ray diffraction, FIG. 6, and found to be a zirconia yttrium tantalate phase along with a very small amount of NiO, along with the underlying tetragonal zirconia electrolyte. In FIG. 6 the dashed line corresponds to 89-9068 Zirconia (Ydoped), syn-(Zr_{0.94}Y_{0.06})O_{1.88}; the dotted line corresponds to 43-0308-Zr_{0.66}Y_{0.17}Ta_{0.17}O₂-Tantalum Yttrium Zirconium Oxide and a sold line corresponds to 89-7390-Bunsenite, synthetic NiO. The numbers 17-0458 and 43-0308 are crystal phase identifiers, and are diffraction file numbers, available for example, from PDF4 diffraction database. The PDF4 database is distributed by the International Center for Diffraction Data (ICDD). The d-space values are provided in angstroms (A)). SEM examination of fractured and polished sections showed a well defined layer about 1-3 microns thick with some porosity on the surface of the electrolyte, FIGS. 7a and 7b. No sign of micro-cracking or monoclinic zirconia was noted in x-ray diffraction or SEM. With process modification, the layer can have a minimum of porosity that extends through the layer at any substantial amount of the area of the coating or be closed porosity or dense. Thicker layers are possible and thinner layers are possible with other coating methods, such as e-beam deposition, sputtering, CVD, sol gel, PVD, etc.

### Example 2

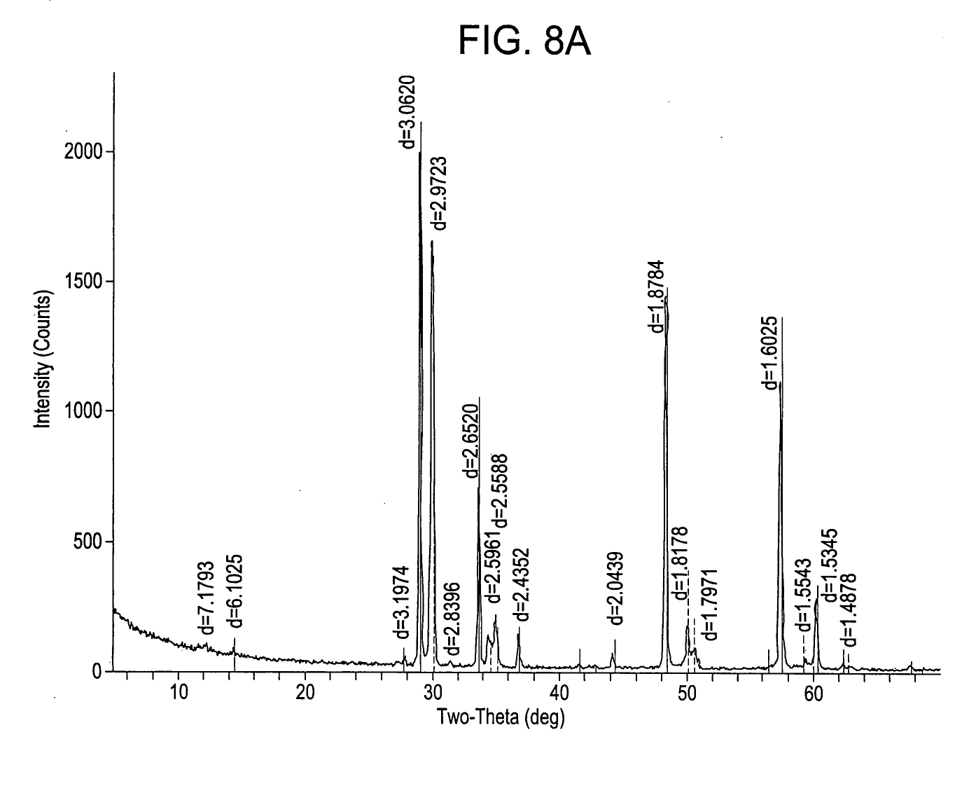

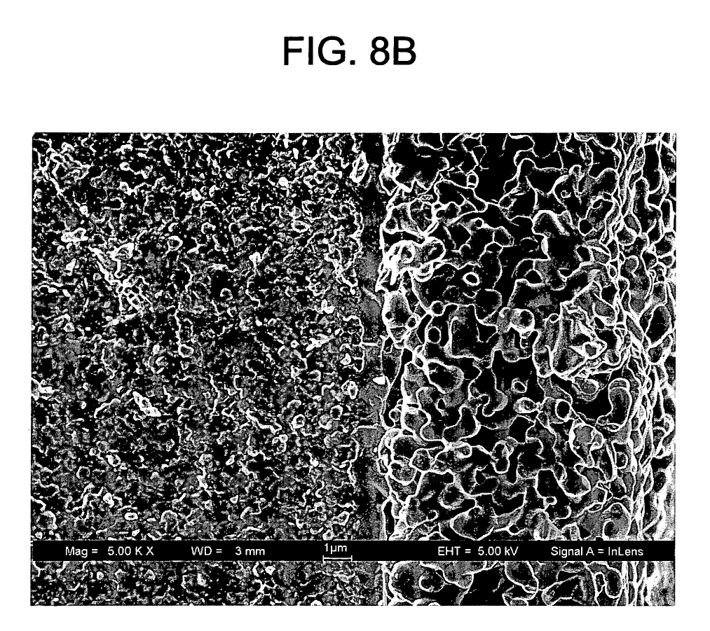

For Nd₂Zr₂O₇ layers, NdCO₃ was calcined to Nd₂O₃. The Nd₂O₃ was milled with undoped zirconia powder TZ-0Y, Tosho, using vibro-milling in an ethanol fluid with Tosoh TZ3Y zirconia media. After drying, the milled powder was reacted at about 120° C. for several hours in air. The powder was vibro-milled a second time for 24 hours. After drying, the powder was made into inks using a three roll mill. The composition was screen printed onto zirconia 3-mole % yttria electrolyte and the sample dried, then fired at ˜1400 C for several hours in air. The phases in the sample were identified by x-ray diffraction, FIG. 8a, and found to be a pyrochlore neodymium zirconate phase along with the underlying tetragonal zirconia electrolyte. The d-space values are provided in angstroms (A)). The numbers 17-0458 and 89-9068 are crystal phase identifiers, and are diffraction file numbers, available for example, from PDF4 diffraction database. In FIG. 8A the sold line corresponds to the 17-0458-Nd₂Zr₂O₇ Neodimium Zirconium Oxide, and the dashed line corresponds to 89-9068-Zirconia (Ydoped), synthetic (Zr_{0.94}Y_{0.06})O_{1.88}. The 7.18 A and possibly 2.84 A peak is from a clay sample support. SEM examination of fractured and polished sections showed a well defined layer about 10 microns thick with porosity, FIG. 8b. A thin 1 micron fully dense layer was found between the neodymium zirconate and the underlying zirconia 3-mole % yttria electrolyte. This thin dense layer could be neodymium zirconate or a cubic zirconia with a mixed yttrium oxide, neodymium oxide stabilizer. No sign of micro-cracking or monoclinic zirconia was noted in x-ray diffraction or SEM. With process modification, the neodymium zirconate layer can have a minimum of porosity that extends through the layer at any substantial amount of the area of the coating, be closed porosity or dense. Thicker layers are possible and thinner layers are possible. Other coating methods, such as e-beam deposition, sputtering, CVD, etc. can be utilized.

Various modifications and variations can be made to the compositions, articles, devices, and methods described herein. Other aspects of the compositions, articles, devices, and methods described herein will be apparent from consideration of the specification and practice of the compositions, articles, devices, and methods disclosed herein. It is intended that the specification and examples be considered as exemplary.

What is claimed is:

1. A solid oxide fuel cell comprising a cathode, an anode, an electrolyte, a bus bar, a via pad, a seal, and an insulating amount of an insulating composition, wherein the insulating composition is proximate to the bus bar and/or the via pad and/or is present in part of the electrolyte, wherein the insulating composition is not substantially disposed between the cathode and the electrolyte.

2. A solid oxide fuel cell comprising a cathode, an anode, an electrolyte, a bus bar, a via pad, a seal, and an insulating amount of an insulating composition, wherein the insulating composition is proximate to the bus bar and/or the via pad and/or is present in part of the electrolyte, wherein the insulating composition is not lanthanum zirconate or strontium zirconate.

3. The solid oxide fuel cell of claim 2, wherein the insulating composition is not a rare earth zirconate or an alkaline earth zirconate.

4. A solid oxide fuel cell comprising a cathode, an anode, an electrolyte, a bus bar, a via pad, a seal, and an insulating amount of an insulating composition comprising one or more insulating oxide ceramics having the following crystal structure class, super class, derivative structure or superstructure of the following crystal structure type:
i) pyrochlore or distorted pyrochlore,
ii) perovskite, distorted perovskite, superstructure of perovskite, or interleaved perovskite-like structure,
iii) fluorite, distorted fluorite, fluorite like, anion defective fluorite, sheelite, fergusonite, or fluorite related ABO₄ compound,
iv) spinel, spinel derived structure, or inverse spinel,
v) rock salt structure,
vi) ilmenite,
vii) pseudobrookite A₂BO₅,
viii) stoichiometric structure based on ReO₃-like blocks,
ix) bronze or tetragonal bronze structure based on ReO₃-like blocks,
x) rutile;
xi) trirutile crystal structure or columbite crystal structure of AB₂O₆,
xii) cubic rare earth (C-M₂O₃) structure, or
xiii) corundum, or
a mixture thereof or a solid solution thereof.
wherein the insulating composition is proximate to the bus bar and/or the via pad and/or is present in part of the electrolyte.

5. The solid oxide fuel cell of claim 4, wherein the insulating composition is proximate to the bus bar and/or via pad.

6. The solid oxide fuel cell of claim 4, wherein the insulating composition is in contact with the bus bar and/or via pad.

7. The solid oxide fuel cell of claim 4, wherein the insulating composition is in contact with the electrolyte.

8. The solid oxide fuel cell of claim 4, wherein the insulating composition is in contact with the bas bar and the electrolyte.

9. The solid oxide fuel cell of claim 4, wherein the insulating composition is in contact with the via pad and the electrolyte.

10. The solid oxide fuel cell of claim 4, wherein the insulating composition is in contact with two or more via pads and the electrolyte.

11. The solid oxide fuel cell of claim 4, wherein the insulating composition is a continuous layer in contact with two or more via pads and the electrolyte.

12. The solid oxide fuel cell of claim 4, wherein the insulating composition is present in part of the electrolyte.

13. The solid oxide fuel cell of claim 4, wherein the insulating composition is present across part of the diameter in part of the electrolyte.

14. The solid oxide fuel cell of claim 4, wherein the insulating composition is present across the entire diameter in part of the electrolyte.

15. The solid oxide fuel cell of claim 4, wherein the insulating composition is present in part of the electrolyte and is present in at least one discrete section.

16. The solid oxide fuel cell of claim 4, wherein the insulating composition is present in part of the electrolyte and is proximate the seal.

17. The solid oxide fuel cell of claim 4, wherein the insulating composition is present in part of the electrolyte and is in contact with the seal.

18. The solid oxide fuel cell of claim 4, wherein the insulating composition is present in part of the electrolyte and is not in contact with the seal.

19. The solid oxide fuel cell of claim 4, wherein the insulating composition is present in part of the electrolyte and is between the electrode and the seal.

20. The solid oxide fuel cell of claim 4, wherein the insulating oxide ceramic comprises one or more of
i) pyrochlore or distorted pyrochlore crystal structure according to the formula
(1) A₂B₂O₇ having the valence A³⁺₂B⁴⁺₂O₇, wherein
A³⁺ is Sc, Y, La, Nd, Eu, Gd, or other 3+ lanthanide and
B⁴⁺ is Zr, Ti, Hf, or Sn, or
(2) A₂B₂O₇ having the valence A²⁺₂B⁵⁺₂O₇, wherein
A²⁺ is Ca, Sr, Zn, or Ba and
B⁵⁺ is Nb, Ta, or V,
ii) perovskite; distorted perovskite crystal structure; superstructure of perovskite according to the formula ABO₃
(1) having the valence A²⁺B⁴⁺O₃, wherein
A²⁺ is Mg, Ca, Sr, or Ba and
B⁴⁺ is Ti, Zr, Hf, or Sn,
(2) having the valence A³⁺13³⁺O₃, wherein
A³⁺ is Sc, Y, La, or a 3+ lanthanide and
B³⁺ is Al, Ga, Cr, Sc, V, or Y,
(3) having the valence A²⁺(B³⁺_{0.5}B⁵⁺_{0.5})O₃, wherein
A²⁺ is Ca, Sr, or Ba,
B³⁺ is Al, Cr, Ga, Sc, Y, La, Ce, or other 3+ lanthanide,
B⁵⁺ is V, Nb, Ta, or Sb,
(4) having the valence A²⁺(B²⁺_{0.33}B^{5÷}_{0.67})O₃, wherein
A²⁺ is Ca, Sr, or Ba,
B²⁺ is Mg, Ca, Cd, Ni, or Zn,
B⁵⁺ is Nb, Ta, or Sb,
(5) having the valence A²⁺(B²⁺_{0.5}B⁶⁺_{0.5})O₃, wherein
A²⁺ is Ca, Sr, or Ba,
B²⁺ is Mg, Ca, Sr, Ba, Cd, Ni, or Zn,
B⁶⁺ is Mo, W or Re,
(6) having the valence A³⁺_{0.33}B⁵⁺O₃, wherein
A³⁺ is Y, La, Ce, Pr, Nd, Sm, Gd, Dy, Ho, or Er,
B⁵⁺ is Nb or Ta, or
(7) having the valence'A³⁺(B²⁺_{0.5}B⁴⁺_{0.5})O³, where A³⁺ is La or a lanthanide, B²⁺is Mg, and B⁴⁺ is Ti,
interleaved Bi₂O₂, or
perovskite-like structure,
iii)
(1) fluorite or distorted fluorite of A_{1-x-y}BₓC_{y}O_{2+/-z}, where A is Zr, Hf, or Ce, B is Mg, Ca, Y, Sc, or a rare earth, C is V, Nb, or Ta, where x<1, y<1 and x+y<1, and z depends upon the valence of B and C, wherein, if B is 2+, then z=2+0.5y−x, and if B is 3+, then z=2+0.5y−0.5×,
(2) a fluorite like compound of A_{1-x-y}BₓC_{y}O_{2+/-z}, where A is Zr, Hf, or Ce, B is Mg or Ca, and C is W or Mo, where x<1, y<1, x+y<1, and z is 2+y−x,
(3) a sheelite type structure of ABO₄, where A is Mg or Ca and B is W or Mo,
(4) a fergusonite type structure of M^{III}NbO₄, M^{III}TaO₄ or M^{III}VO₄, where M^{III} is a metal of valence +3, or formula ABO₄ where A is Y or a rare earth and B is Nb, Ta or V,
(5) an anion defective fluorite, or
(6) a fluorite related ABO₄ compound, with valence A²⁺B⁶⁺O₃ or A³⁺B⁵⁺O₃, wherein A²⁺ is Ca or Ba, B⁶⁺ is Cr, A³⁺ is Cr, and B⁵⁺ is Nb,
iv)
(1) spinel structure or a spinel derived structure of AB₂O₄, where A is Mg, Ni, Zn, Co, Fe, or Mn and B is Al, Ga, Cr, or Fe,
(2) A₃B₃₂O₅₁, where A is Ca, Ba, or Sr and B is Al, or
(3) an inverse spinel or A₂BO₄, wherein A is Mg or Zn and B is Ti or Sn,
v) rock salt structure AO, where A is Mg, Ca, Sr, Ba, or Ni,
vi) ilmenite of formula ABO₃, wherein A is Ni, Co, Mn or Fe and B is Ti, or giekielite where A is Mg and B is Ti,
vii) pseudobrookite crystal structure of the formula A₂BO₅, where A is Al or Fe and B is Ti,
viii) a tetragonal bronze structure based on ReO₃-like blocks or a Nb₂O₅—WO₃ mixture,
ix) a tetragonal bronze of valence A²⁺B⁵⁺₂O₆, wherein A²⁺ is Sr or Ba and B⁵⁺ is Nb or Ta, or the superstructure A²⁺₅B⁵⁺₁₀O₃₀, A²⁺₆B⁴⁺₂B⁵⁺₈O₃₀, or A²⁺₅B³⁺B⁴⁺₃B⁵⁺₇O₃₀, where A²⁺ is Ca, Sr, or Ba, B³⁺ is La or a lanthanide, B⁴⁺is Ti, and B⁵⁺ is Nb or Ta,
x) rutile structure of AO₂, wherein A is Ti, Sn, or Mn,
xi) a trirutile crystal structure of AB₂O₆, where A is Mg, Cr, or V and B is Ta, W, or Sb; or CaTa₂O₆,
xii) a cubic rare earth (C-M₂O₃) structure A₂O₃, where A is Y or a rare earth, or
xiii) a corundum structure A₂O₃, where A is Al, Ga, or Cr, or ABO₃, wherein A is Ni and B is Cr,
or a mixture thereof or a solid solution thereof.

21. The solid oxide fuel cell of claim 4, wherein the insulating oxide ceramic comprises one or more of
i) pyrochlore or distorted pyrochlore crystal structure of La₂Zr₂O₇, Y₂a₂O₇, Nd₂Zr₂O₇, Gd₂Zr₂O₇, Er₂Zr₂O₇, La₂Hf₂O₇, Y₂Hf₂O₇, Nd₂Hf₂O₇, Gd₂Hf₂O₇, Er₂Hf₂O₇, La₂Sn₂O₇, Y₂Sn₂O₇, Nd₂Sn₂O₇, Gd₂Sn₂O₇, or Er₂Sn₂O₇,
ii) perovskite, distorted perovskite crystal structure, superstructure of perovskite, or interleaved perovskite-like structure of SrZrO₃, BaZrO₃, SrHfO₃, BaHfO₃, SrSnO₃, BaSnO₃, BaTiO₃, or SrTiO₃,
iii) fluorite; distorted fluorite of A_{1-x-y}BₓC_{y}O_{2+/-z}, where A is Zr, Hf, or Ce and B is Mg, Ca, Y, Sc, or a rare earth and C is V, Nb, or Ta where x<1, y<1, x+y<1, y/x>0.5, and z depends upon the valence of B and C, wherein, if B is 2+, then z=2+0.5y−x, and if B is 3+, then z=2+0.5y−0.5x; fluorite like compound of A_{1-x-y}BₓC_{y}O_{2+/-z}, where A is Zr, Hf, or Ce, B is Mg or Ca and C is W or Mo, where x<1, y<1, x+y<1, y/x>0.5, and z is 2+y−x; sheelite type structure of ABO₄, where A is Mg or Ca, B is W or Mo; fergusonite type structure of M^{III}NbO₄, M^{III}TaO₄, or M^{III}VO₄; or formula ABO₄, where A is Y or a rare earth and B is Nb, Ta or V,
iv) spinel or spinel derived structure of MgAl₂O₄, ZnAl₂O₄, MnAl₂O₄, CoAl₂O₄, or
v) a rock salt structure of MgO, CaO, SrO, or NiO, or
vi) rutile AO₂ structure, wherein A is Ti or Sn,
or a mixture thereof or a solid solution thereof.

22. The solid oxide fuel cell of claim 4, wherein the electrolyte is disposed between the anode and the cathode, the anode of one fuel cell is electrically connected to the cathode of another fuel cell by a via pad at the anode and a via pad at the cathode, the via pads are electrically connected to each other with a via fill that traverses through the electrolyte, the bus bar is electrically connected to the electrode at each end of the electrolyte, and the seal is disposed between the electrolyte and a frame adjoining the seal.

23. A solid oxide fuel cell comprising a cathode, an anode, an electrolyte, a bus bar, a via pad, a frame, a seal, and an insulating amount of an insulating composition comprising one or more insulating oxide ceramics having the following crystal structure class, super class, derivative structure or superstructure of the following crystal structure types:
i) pyrochlore or distorted pyrochlore,
ii) perovskite, distorted perovskite, superstructure of perovskite, or interleaved perovskite-like structure,
iii) fluorite, distorted fluorite, fluorite like, anion defective fluorite, sheelite, fergusonite, or a fluorite related ABO₄ compound,
iv) ilmenite,
v) pseudobrookite A₂BO₅,
vi) stoichiometric structure based on ReO₃-like blocks,
vii) bronze or tetragonal bronze structure based on ReO₃-like blocks,
viii) rutile,
ix) trirutile crystal structure or columbite crystal structure of AB₂O₆, or
x) cubic rare earth (C-M₂O₃) structure, or
a mixture thereof or a solid solution thereof,
wherein the insulating composition is proximate to the frame of the solid oxide fuel cell.

24. The solid oxide fuel cell of claim 23, wherein the insulating composition is adjacent to and in contact with the frame.

25. The solid oxide fuel cell of claim 23, wherein the insulating composition is disposed between the frame and the seal, wherein the seal is disposed between the insulating composition and the electrolyte.

26. The solid oxide fuel cell of claim 23, wherein the insulating oxide ceramic comprises one or more of
i) pyrochlore or distorted pyrochlore crystal structure according to the formula
(1) A₂B₂O₇ having the valence A³⁺₂B⁴⁺₂O₇, wherein
A³⁺ is Sc, Y, La, Nd, Eu, Gd, or other 3+ lanthanide and
B⁴⁺ is Zr, Ti, Hf, or Sn, or
(2) A₂B₂O₇ having the valence A²⁺₂B⁵⁺₂O₇, wherein
A²⁺ is Ca, Sr, Zn, or Ba, and
B⁵⁺ is Nb, Ta, or V,
ii) perovskite; distorted perovskite crystal structure; superstructure of Perovskite according to the formula ABO₃
(1) having the valence A²⁺13⁴⁺O₃, wherein
A²⁺ is Mg, Ca, Sr, or Ba and
B⁴⁺ is Ti, Zr, Hf, or Sn,
(2) having the valence A³⁺B³⁺O₃, wherein
A³⁺ is Sc, Y, La, or a 3+ lanthanide and
B³⁺ is Al, Ga, Cr, Sc, V, or Y,
(3) having the valence A²⁺(B³⁺_{0.5}B⁵⁺_{0.5})O₃, wherein
A²⁺ is Ca, Sr, or Ba,
B³⁺ is Al, Cr, Ga, Sc, Y, La, Ce, or other 3+ lanthanide,
B⁵⁺ is V, Nb, Ta, or Sb,
(4) having the valence A²⁺(B²⁺_{0.33}B⁵⁺_{0.67})O₃, wherein
A²⁺ is Ca, Sr, or Ba,
B²⁺ is Mg, Ca, Cd, Ni, or Zn,
B⁵⁺ is Nb, Ta, or Sb,
(5) having the valence A²⁺(B²⁺_{0.5}B⁶⁺_{0.5})O₃, wherein
A²⁺ is Ca, Sr, or Ba,
B²⁺ is Mg, Ca, Sr, Ba, Cd, Ni, or Zn,
B⁶⁺ is Mo, W or Re,
(6) having the valence A³⁺_{0.33}B⁵⁺O₃, wherein
A³⁺ is Y, La, Ce, Pr, Nd, Sm, Gd, Dy, Ho, or Er,
B⁵⁺ is Nb or Ta, or
(7) having the valence A³⁺(B²⁺_{0.5}B⁴⁺_{0.5})O₃, where A³⁺ is La or a lanthanide, B²⁺is Mg, and B⁴⁺ is Ti,
interleaved Bi₂O₂, or
a perovskite-like structure,
iii)
(1) fluorite or distorted fluorite of A_{1-x-y}BₓC_{y}O_{2+/-z}, where A is Zr, Hf, or Ce, B is Mg, Ca, Y, Sc, or a rare earth, C is V, Nb, or Ta, where x<1, y<1, x+y<1, and z depends upon the valence of B and C, wherein, if B is 2+, then z=2+0.5y−x, and if B is 3+, then z=2+0.5y−0.5x,
(2) a fluorite like compound of A_{1-x-y}BₓC_{y}O_{2+/-z}, where A is Zr, Hf, or Ce, B is Mg or Ca, and C is W or Mo, where x<1, y<1 and x+y<1, and z is 2+y−x,
(3) a sheelite type structure of ABO₄, where A is Mg or Ca and B is W or Mo,
(4) a fergusonite type structure of M^{III}NbO₄, M^{III}TaO₄ or M^{III}VO₄, where M^{III} is a metal of valence +3, or formula ABO₄ where A is Y or a rare earth and B is Nb, Ta or V,
(5) an anion defective fluorite, or
(6) a fluorite related ABO₄ compound, with valence A²⁺B⁶⁺O₃ or A³⁺B⁵⁺O₃, wherein A²⁺ is Ca or Ba, B⁶⁺ is Cr, A³⁺ is Cr, and B⁵⁺ is Nb,
iv) ilmenite of formula ABO₃, wherein A is Ni, Co, Mn or Fe and B is Ti, or giekielite where A is Mg and B is Ti,
v) pseudobrookite crystal structure of the formula A₂BO₅, where A is Al or Fe and B is Ti,
vi) a tetragonal bronze structure based on ReO₃-like blocks or a Nb₂O₅—WO₃ mixture,
vii) a tetragonal bronze of valence A²⁺B⁵⁺₂O₆, wherein A²⁺ is Sr or Ba and B⁵⁺ is Nb or Ta, or the superstructure A²⁺₅B⁵⁺₁₀O₃₀, A²⁺₆B⁴⁺₂B⁵⁺₈O₃₀, or A²⁺₅B³⁺B⁴⁺₃B⁵⁺₇O₃₀, where A²⁺ is Ca, Sr, or Ba, B³⁺ is La or a lanthanide, B⁴⁺is Ti, and B⁵⁺ is Nb or Ta,
viii) rutile structure of AO₂, wherein A is Ti, Sn, or Mn,
ix) a trirutile crystal structure of AB₂O₆, where A is Mg, Cr, or V and B is Ta, W, or Sb; or CaTa₂O₆, or
x) a cubic rare earth (C-M₂O₃) structure A₂O₃, where A is Y or a rare earth,
or a mixture thereof or a solid solution thereof.

27. The solid oxide fuel cell of claim 23, wherein the insulating oxide ceramic comprises one or more of
i) pyrochlore or distorted pyrochlore crystal structure of La₂Zr₂O₇, Y₂Zr₂O₇, Nd₂a₂O₇, Gd₂a₂O₇, Er₂a₂O₇, La₂Hf₂O₇, Y₂W₂O₇, Nd₂Hf₂O₇, Gd₂Sn₂O₇, Er₂Hf₂O₇, La₂Sn₂O₇, Y₂Sn₂O₇, Nd₂Sn₂O₇, Gd₂Sn₂O₇, or Er₂Sn₂O₇,
ii) perovskite, distorted perovskite crystal structure, superstructure of perovskite, or interleaved perovskite-like structure of SrZrO₃, BaZrO₃, SrHfO₃, BaHfO₃, SrSnO₃, BaSnO₃, BaTiO₃, or SrTiO₃,
iii) fluorite; distorted fluorite of A_{1-x-y}BₓC_{y}O_{2+/-z}, where A is Zr, Hf, or Ce and B is Mg, Ca, Y, Sc, or a rare earth and C is V, Nb, or Ta where x<1, y<1, x+y<1, y/x>0.5 and z depends upon the valence of B and C, wherein, if B is 2+, then z=2+0.5y−x, and if B is 3+, then z=2+0.5y−0.5x; fluorite like compound of A_{1-x-y}BₓC_{y}O_{2+/-z}, where A is Zr, Hf, or Ce, B is Mg or Ca and C is W or Mo, where x<1, y<1, x+y<1, y/x>0.5, and, and z is 2+y−x; sheelite type structure of ABO₄, where A is Mg or Ca, B is W or Mo; fergusonite type structure of M^{III}NbO₄, M^{III}TaO₄, or M^{III}VO₄; or formula ABO₄ where A is Y or a rare earth and B is Nb, Ta or V, or
iv) rutile AO₂ structure, wherein A is Ti or Sn,
or a mixture thereof or a solid solution thereof.

28. The solid oxide fuel cell of claim 23, wherein insulating oxide ceramic is not yttria stabilized zirconia or lanthanium zirconate.

29. The solid oxide fuel cell of claim 23, wherein the one or more insulating oxide ceramics has the following crystal structure class, super class, derivative structure or superstructure of the following crystal structure types:
i) perovskite, distorted perovskite, superstructure of perovskite, or interleaved perovskite-like structure,
ii) fluorite, distorted fluorite, fluorite like, anion defective fluorite, sheelite, fergusonite, or a fluorite related ABO₄ compound,
iii) ilmenite,
iv) pseudobrookite A₂BO₅,
v) stoichiometric structure based on ReO₃-like blocks,
vi) bronze or tetragonal bronze structure based on ReO₃-like blocks,
vii) rutile,
viii) trirutile crystal structure or columbite crystal structure of AB₂O₆, or
ix) cubic rare earth (C-M₂O₃) structure, or
a mixture thereof or a solid solution thereof.

30. The solid oxide fuel cell of claim 23, wherein the electrolyte is disposed between the anode and the cathode, the anode of one fuel cell is electrically connected to the cathode of another fuel cell by a via pad at the anode and a via pad at the cathode, the via pads are electrically connected to each other with a via fill that traverses through the electrolyte, the bus bar is electrically connected to the electrode at each end of the electrolyte, and the seal is disposed between the electrolyte and a frame adjoining the seal.
